(19) United States
(12) Patent Application Publication
(10) Pub. No.: US 2016/0014127 A1
(43) Pub. Date: Jan. 14, 2016

(54) METHODS AND APPARATUS FOR HYBRID ACCESS TO A CORE NETWORK BASED ON PROXIED AUTHENTICATION

(71) Applicant: Behzad Mohebbi, San Diego, CA (US)

(72) Inventor: Behzad Mohebbi, San Diego, CA (US)

(21) Appl. No.: 14/863,239

(22) Filed: Sep. 23, 2015

Related U.S. Application Data
(63) Continuation-in-part of application No. 14/156,339, filed on Jan. 15, 2014.
(60) Provisional application No. 62/071,517, filed on Sep. 25, 2014.
(60) Provisional application No. 61/849,087, filed on Jan. 18, 2013.
(60) Provisional application No. 61/848,950, filed on Jan. 16, 2013.

(51) Int. Cl. H04L 29/06; H04W 12/04; H04W 12/06

(52) U.S. Cl. CPC H04L 63/0884; H04W 12/06; H04L 69/161; H04L 63/061; H04W 12/04; H04W 84/045

(57) ABSTRACT

Apparatus and methods for hybrid access to a core network. In one embodiment, a wireless station enables a subscriber device to connect to a core network via an intermediate network (e.g., a Wi-Fi network) rather than the network traditionally associated with the core network (e.g., a cellular network). In one implementation, the subscriber device connects to the wireless station at the (Transmission Control Protocol/Internet Protocol) TCP/IP layers. Methods and apparatus for securely authenticating the subscriber device via the wireless station are disclosed. In one such variant, the subscriber device is a SIM-less device.

### PRIORITY AND RELATED APPLICATIONS

This application claims priority to co-owned, co-pending U.S. Provisional Patent Application Ser. No. 62/071,517 entitled “METHODS AND APPARATUS FOR HYBRID ACCESS TO A CORE NETWORK”, filed Sep. 25, 2014, and is also a continuation-in-part of and claims priority to co-owned, co-pending U.S. patent application Ser. No. 14/156,339 entitled “METHODS AND APPARATUS FOR HYBRID ACCESS TO A CORE NETWORK”, filed Jan. 15, 2014, which claims priority to U.S. Provisional Patent Application Serial Nos. 61/849,087 filed on Jan. 18, 2013 and entitled “NETWORK AGNOSTIC WIRELESS ROUTER (NAWR)”, and 61/848,950 filed on Jan. 16, 2013 and entitled “WI-FI OVER LTE NETWORK (WOLTEN)”, each of the foregoing being incorporated herein by reference in its entirety.

This application is related to commonly owned and co-pending U.S. patent application Ser. No. 14/156,174, entitled “METHODS AND APPARATUS FOR A NETWORK-AGNOSTIC WIRELESS ROUTER”, filed Jan. 15, 2014, the foregoing being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Technological Field

The present disclosure relates generally to the field of wireless communication and data networks. More particularly, in one exemplary aspect, the disclosure is directed to methods and apparatus for hybrid access to a core network.

2. Description of Related Technology

The rapid growth of mobile data services accelerated by, inter alia, the advent of so-called “smartphone” technologies has resulted in a steep increase in the volume of high-speed data transmission and the popularity of mobile services. Coupled with increased popularity is the increased customer expectation for better and more reliable services and network capabilities. Short term solutions for alleviating high capacity demands include unpopular practices such as “data rate throttling”, introducing limited and expensive tariffs, and phasing out “unlimited data plans”. Longer term solutions require new access technologies (such as Long Term Evolution (LTE)) to meet the customer demands, and further require costly infrastructure investments.

Examples of incipient solutions include e.g., so-called “small cell” (e.g., femtocells, picocells, and microcells), “HetNet” (heterogeneous network) and “Wi-Fi Offloading”. As a brief aside, small cell technologies require backhaul connectivity to the network operator's core network; this can complicate deployment as small cells may not have access to sufficient frequency resources, but still require the high capacity underlay (i.e., carrier grade connectivity must be provided at much higher cost per bit). HetNets incorporate multiple different network technologies, and can experience co-channel interference between macro cells and underlay cells. In contrast, there is no shortage of spectrum with “Wi-Fi offloading”, Wi-Fi hotspots operate in unlicensed (license exempt) bands where there is an abundance of spectrum (the Industrial Scientific and Medical (ISM) and Unlicensed National Information Infrastructure (U-NII) bands may provide nearly 0.5 GHz of spectrum). For this reason, Wi-Fi offloading is very attractive to network operators; in fact, some small cell base stations have integrated Wi-Fi Access Point (AP) functionalities (e.g., “Wi-Fi ready”).

Despite these benefits, there are several fundamental problems associated with Wi-Fi offloading systems and networks. Existing network operators treat the cellular and Wi-Fi networks as two separate business units, which are operated and managed separately. There is also very little integration and interworking between the two networks at operation and services levels. For example, Wi-Fi networks do not have a standard “discovery”, “selection” and “access” mechanism and/or procedure. This can result in difficulty getting onto these networks and/or inconsistent Quality of Service (QoS), security and policies. Moreover, cellular networks typically implement a single subscriber identification module (SIM) that is configured to acquire, register, authenticate and cipher communications; in contrast, Wi-Fi networks are based on a variety of “web-based” authentication methods which rely on Wireless Internet Service Provider roaming (WISPr) (or similar variant). WISPr requires that the user enter a user name and a password, which are then authenticated by e.g., an Authentication, Authorization, and Accounting (AAA)/Remote Authentication Dial-In User Service (RADIUS) server; this step is both inconvenient and prone to error.

In view of these deficiencies, improved methods and apparatus are needed to enable access to mobile wireless (e.g., cellular) networks utilizing other network technologies. Such improvements would ideally provide an integrated solution for merging e.g., Wi-Fi and cellular networks, making e.g., user experience, policy control, discovery, selection and association, authentication, and QoS, seamless and similar in both networks. Other benefits may include e.g., Wi-Fi roaming, Wi-Fi neutral host, and IP-mobility capabilities, while providing network handoffs for an integrated cellular-Wi-Fi network.

### SUMMARY OF THE DISCLOSURE

The present disclosure satisfies the aforementioned needs by providing, inter alia, improved apparatus and methods for hybrid access to a core network.

A method for wireless communications including a first and a second communications systems, where the first communications system has at least a first node and a second node in communications with each other, is disclosed. In one embodiment, the method includes: executing a first portion of layers within the first node, and causing the second node to execute a second portion of layers; providing one or more identifying information from the first node to the second node, the one or more identifying information in conjunction with the execution of the second portion of layers configured to authenticate the first node with at least one logical entity in the first communications system; and wherein successful authentication establishes a connection between the second node and the at least one logical entity.

In one variant, the executing the second portion of layers within the second node includes coupling to a Transmission Control Protocol/Internet Protocol) TCP/IP layer of the first node.

In a second variant, the executing the first portion of layers within the first node includes coupling to a complementary Transmission Control Protocol/Internet Protocol) TCP/IP layer of the second node.

In a third variant, the method includes causing the second portion of layers to derive one or more authentication information; and based on the derived one or more authentication information, the second portion of layers further configured to encrypt one or more data payloads for a first link between the second node and the at least one logical entity. In one such variant, the method further include deriving the one or more authentication information at the first portion of layers; and based on the derived one or more authentication information, encrypting one or more data payloads for the second portion of layers at the first portion of layers.

In a fourth variant, the method includes receiving the one or more identifying information from a subscriber identity module (SIM) that is not local to the first node. In one such case, the providing the one or more identifying information from the first node to the second node is performed via a public key encryption scheme. In one exemplary variant, the public key encryption scheme includes receiving a manually entered password from a user input. In another variant, the public key encryption scheme includes retrieving a pre-defined public key.

A wireless station apparatus configured to provide connectivity to a core network is disclosed. In one embodiment, the wireless station apparatus includes: a network interface, the network interface configured to connect to the core network associated with a second radio technology; a radio interface, the radio interface configured to provide an open wireless network according to a first radio technology different than the second radio technology; a processor; and a non-transitory computer readable medium in data communication with the processor and including one or more instructions. In one exemplary embodiment, when executed by the processor, the one or more instructions cause the wireless station apparatus to, responsive to a subscriber device of the open wireless network requesting access to the core network: receive one or more identifying information from the subscriber device; authenticate to the core network based on the one or more identifying information via the network interface, wherein the authentication results in a derivation of one or more authentication keys; and establish a secure link to the subscriber device via the open wireless network based on the one or more authentication keys.

In one variant, the one or more instructions when executed by the processor, cause the wireless station apparatus to execute one or more software layers that are uniquely associated with the subscriber device and the second radio technology.

In a second variant, the executed one or more software layers mimic one or more portions of a call stack associated with the subscriber device. In some cases, at least one software layer is mimicked that authenticates the subscriber device to the second radio technology.

In a third variant, the received one or more identifying information is received via a public key encryption; and where the established secure link is based on a symmetric key encryption.

A subscriber device configured to communicate with a core network via a wireless station is disclosed. In one embodiment, the subscriber device includes: a radio interface, the radio interface configured to communicate with a wireless station, where the wireless station is configured to communicate with the core network; a processor; and a non-transitory computer readable apparatus including one or more instructions. In one exemplary embodiment, the one or more instructions are configured to when executed by the processor, cause the subscriber device to: provide one or more identifying information to the wireless station; wherein the wireless station is configured to communicate with the core network; receive one or more authentication information from the wireless station; and establish a secure connection to the wireless station based on one or more keys derived from the one or more authentication information.

In one variant, the identifying information includes a Long Term Evolution (LTE) evolved Packet System (EPS) KASME (Key Access Security Management Entity) encryption key.

In a second variant, the subscriber device is further configured to authorize the use of its one or more identifying information by at least one other subscriber device. In one such variant, the at least one other subscriber device shares the secure connection to the wireless station. In another variant, the subscriber device is further configured to request another internet protocol (IP) address for the at least one other subscriber device.

In a third variant, the one or more identifying information is provided to the wireless station via a public key encryption scheme.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a block diagram representation of one prior art 3^{rd} Generation Partnership Project (3GPP) Release 8 network architecture.

FIG. 2 is a block diagram representation of one exemplary embodiment of a Wi-Fi over Long Term Evolution (WoLTEN) network architecture.

FIG. 3 is a logical block diagram representation of one exemplary wireless station configured to provide hybrid access to a core network in accordance with various principles described herein.

FIG. 4 is a logical block diagram representation of one exemplary subscriber device configured to access a core network via a hybrid access scheme in accordance with various principles described herein.

FIG. 5 is a logical block diagram representing a Institute of Electrical and Electronics Engineers (IEEE) 802.11n Physical (PHY) (L1) and Medium Access Control (MAC) (L2) protocol stack useful in conjunction with various aspects of the present disclosure.

FIG. 6 is a logical representation of the Wi-Fi PIPE formed by the exemplary wireless station (e.g., as described in FIG. 3) and the exemplary subscriber device (e.g., as described in FIG. 4).

FIG. 7 is a logical software diagram representation of several of the Logical, Transport and Physical channels of prior art LTE radio architectures.

FIG. 8 is a logical software diagram representation of a prior art LTE software user-plane protocol stack.

FIG. 9 is a logical software diagram representation of a prior art LTE software control-plane protocol stack.

FIG. 10 is a logical software diagram illustrating one exemplary embodiment of a LTE radio user-plane protocol stack that operates between the user equipment (UE) and evolved NodeB (eNB), and a modification thereof, in accordance with various aspects of the present disclosure.

FIG. 11 is a logical software diagram illustrating one exemplary embodiment of the LTE radio control-plane protocol stack that operates between the user equipment (UE) and evolved NodeB (eNB), and a modification thereof, in accordance with various aspects of the present disclosure.

FIG. 11A is a logical block diagram of one exemplary user equipment (UE) in communication with a Wi-Fi access point (AP) using a second exemplary stack arrangement, in accordance with the principles described herein.

FIG. 12 is a logical software diagram illustrating one exemplary embodiment of a conceptual architecture of the LTE MAC, useful in conjunction with various aspects of the present disclosure.

FIG. 13 is a logical software diagram representation of an overall protocol stack architecture (both user-plane and control-plane) for the subscriber device and the wireless station.

FIG. 14 is a logical flow diagram of one generalized process for discovery, initiation and configuration of a mobility management session.

FIG. 15 is a logical flow diagram illustrating the initialization of a Wi-Fi over Long Term Evolution (WoLTEN) connection of one exemplary WoLTEN application (APP) executed on a subscriber device.

FIG. 16 is a logical flow diagram illustrating the initialization of a Wi-Fi over Long Term Evolution (WoLTEN) connection of one exemplary WoLTEN agent executed on a wireless station.

FIG. 17 is a logical block diagram of one exemplary external subscriber identity module (SIM/USIM) useful in conjunction with the present disclosure.

All Figures © Copyright 2014-2015, nCore Communications, Inc. All rights reserved.

### DETAILED DESCRIPTION OF THE DISCLOSURE

Reference is now made to the drawings, wherein like numerals refer to like parts throughout.

As a brief aside, methods and apparatus for hybrid access to a network, such as a core network, are disclosed in e.g., U.S. patent application Ser. No. 14/156,339 entitled “METHODS AND APPARATUS FOR HYBRID ACCESS TO A CORE NETWORK”, filed Jan. 15, 2014, and U.S. patent application Ser. No. 14/156,174, entitled “METHODS AND APPARATUS FOR A NETWORK-AGNOSTIC WIRELESS ROUTER”, filed Jan. 15, 2014, incorporated supra. As described therein, an “access tunnel” (e.g., a so-called “Wi-Fi PIPE”) enables a subscriber device to contact a core network via an intermediate network (e.g., a Wi-Fi network). In one implementation, the wireless station is configured to directly connect to the core network, using protocols similar (or identical) to existing network entities (e.g., evolved NodeBs (eNBs)). As described in greater detail hereinafter, an exemplary Wi-Fi access point (AP) provides access to a Long Term Evolution (LTE) network. The subscriber device and wireless station are connected via the Wi-Fi PIPE; the wireless station executes a translation process (e.g., a user equipment (UE) medium access control (MAC), virtual physical layer (VPHY), and access point (AP) MAC), thereby seamlessly connecting the subscriber device to the LTE core network.

Various other advantages of the disclosed embodiments are described in greater detail hereinafter.

### DETAILED DESCRIPTION OF EXEMPLARY EMBODIMENTS

Exemplary embodiments of the present disclosure are now described in detail. While these embodiments are primarily discussed in the context of a fourth generation Long Term Evolution (4G LTE or LTE-A) wireless network in combination with Wi-Fi hotspot (IEEE 802.11n) operation, it will be recognized by those of ordinary skill that the present disclosure is not so limited. In fact, the various aspects of the disclosure are useful in any wireless network that can benefit from the wireless routing described herein.

As used herein, the term “wireless” means any wireless signal, data, communication, or other interface including without limitation Wi-Fi (IEEE 802.11 and its derivatives such as “b”, “a”, “g”, “n”, “ac”, etc.), Bluetooth, 3G (e.g., 3GPP, 3GPP2, and UMTS), 4G (LTE, LTE-A, WiMax), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter wave or microwave systems, acoustic, and infrared (i.e., IrDA).

Furthermore, as used herein, the term “network” refers generally to any type of data, telecommunications or other network including, without limitation, data networks (including MANs, PANs, WANs, LANs, WLANs, micronets, piconets, internets, and intranets), satellite networks, cellular networks, and telco networks.

### Existing Solutions for Hybrid Access—

In the past, backhaul and indoor coverage were the two biggest “pain points” for a network operator; more recently, mobile network data capacity has become the challenge. Solutions that increase data capacity while saving time and money for the network operators will have high rewards. Even though, network operators have resisted the adoption of Wi-Fi in their networks, it has become apparent that reasonable solutions to the data capacity problem will require Wi-Fi integration.

As a brief aside, spectrum (or bandwidth) is a rare and expensive resource cost for network operators. While most network operators own ˜10-20 MHz of bandwidth (at most), Wi-Fi networks operate within unlicensed frequency bands which span several hundred MHz of spectrum. A Wi-Fi system that supports Industrial, Scientific and Medical (ISM 2.4 GHz) and Unlicensed National Information Infrastructure (U-NII 5 GHz) bands will have access to approximately 80 MHz of spectrum at ISM and 450 MHz at U-NII bands (excluding outdoor bands). Initially, network operators were concerned about the availability and quality of a license-free (exempt) spectrum and possible negative impacts on user experience; however, unlicensed technologies (such as Wi-Fi) continue to provide stable and effective connectivity even under congested and hostile scenarios.

Unlike cellular technologies, the vast majority of existing Wi-Fi products are based on ad hoc deployments. Wi-Fi networks use Carrier Sense Multiple Access with Collision Avoidance (CSMA/CA) and contention-free (Point Coordination Function (PCF) or Distributed Coordination Function (DCF)) Medium Access Control (MAC) protocols specifically designed to enable ad hoc deployment. Ad hoc deployments reduce the network operator's burden for network planning, deployment and maintenance.

Still further, cellular technologies which were initially designed to support more egalitarian business models (e.g., provide a large number of subscribers with relatively low rate voice capability), Wi-Fi technology was designed to support high throughput from conception. Existing Wi-Fi devices are commonly capable of data rates in excess of 300 Mbits/sec; future revisions promise Gbits/sec data rates.

Wi-Fi technology and devices have been manufactured for more than a decade, and the components were commoditized and available at a relatively low cost. Many existing consumer devices already incorporate Wi-Fi technology, thus the minimal cost of equipment (for both network operators and subscribers) does not present any significant hurdle to deployment.

For at least the aforementioned reasons, so-called “Tier 1” operators (e.g., AT&T® and Verizon®) have requested Wi-Fi integration with the Core Network in recent and future standards development (e.g., Release 12 of the 3^{rd} Generation Partnership Project (3GPP)). Specifically, network operators have concluded that Wi-Fi may have potential applicability as a complementary communication system for: (a) offloading data traffic and (b) improving coverage. More directly, Wi-Fi offloading can alleviate traffic congestion since the available spectrum for Wi-Fi exceeds the network operator's spectrum. Furthermore, Wi-Fi is more cost effective and does not require network planning and operation for “difficult to cover” areas (e.g., indoors), when compared to small cell solution equivalents. To these ends, many newer small-cell base stations (so-called “NodeB” for 3G and evolved NodeB (eNodeB or eNB) for 4G LTE) have incorporated Wi-Fi Access Point (AP) capability.

However, existing solutions suffer from multiple implementation problems. Currently cellular networks that offer Wi-Fi services treat the cellular and Wi-Fi networks as two separate business units, with the two networks operated and managed separately. From an implementation point of view, there is little to no integration and interworking between the two networks at operation and services levels. Additionally, Wi-Fi networks suffer from a lack of a standard “discovery”, “selection” and access mechanisms and procedures. For this reason, the subscriber usually has great difficulty finding and using such networks, and even once found the Quality of Service (QoS) services and policies are not consistent or guaranteed across networks. Inconsistent service provisioning is readily perceptible by subscribers, and can negatively impact customer satisfaction.

As previously noted, Wi-Fi networks are based on web-based authentication methods such as WISPr (or similar variant) which is based on the traditional user name/password paradigm. Despite several major hurdles to implementing subscriber identity module (SIM) operation with Wi-Fi (e.g., support of Extensible Authentication Protocol Authentication Key Agreement (EAP-AKA)), some operators (such as Swisscom®) have used Wi-Fi SIM/USIM based authentication. Similarly, Cisco® has proprietary solutions (e.g., based on the Aggregation Services Router (ASR) series of products and Cisco Prime® for network management), as do Alcatel-Lucent® (e.g., Light Radio a Wi-Fi/WLAN Gateway) and Ericsson® (e.g., Service-Aware Charging and Control (SACC)) and its Network Integrated Wi-Fi solution as an Wi-Fi offloading solution).

Nevertheless, even in these solutions the Wi-Fi network is a separate entity from the cellular network. This distinction leads to different security levels and user experiences, and often requires the operator to manage two separate and distinct networks with additional investment in a number of network and interworking entities. For instance, depending on the solution there may be requirements for new or modified handset functional entities such as EAP-SIM and EAP-AKA for Wi-Fi and routing algorithms (such as client-based IP Flow Mobility and Seamless Offload (IFOM)).

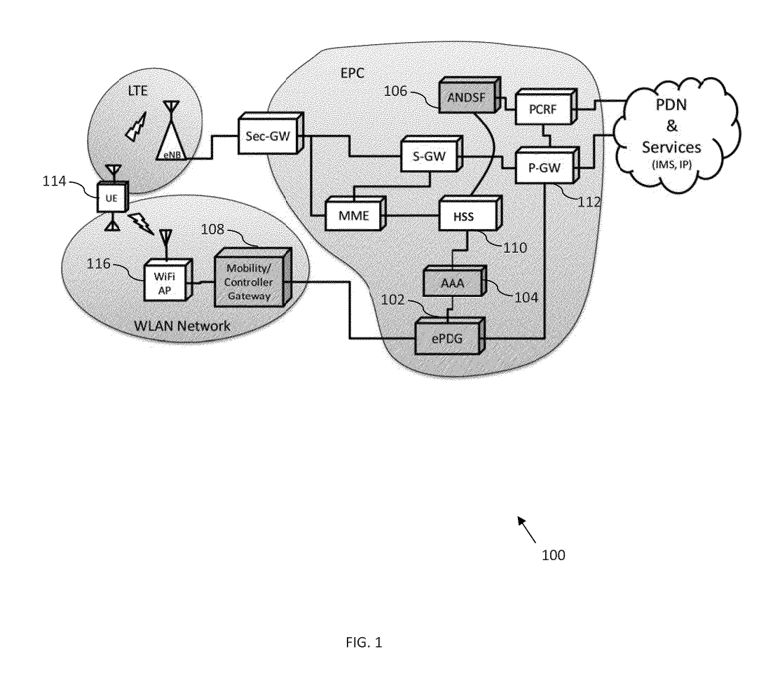

A brief history of the evolution of Wi-Fi Cellular interoperation is presented. In 3GPP Release 6, Interworking-WLAN (I-WLAN) standards were introduced primarily for Wi-Fi integration with 3G networks. This early standard supported IP data through either Wi-Fi or 3G networks, and required a number of new network entities (e.g., Wireless Local Area Network (WLAN) Access Gateway (WAG), Packet Data Gateway (PDG), Authentication Authorization and Accounting (AAA) Server and Home Agent (HA)). Although this standard was not embraced by network operators, I-WLAN was even more tightly integrated in 3GPP Release 8 with the Long Term Evolution (LTE) Core Network (also referred to as the Evolved Packet Core (EPC)). FIG. 1 depicts the prior art 3GPP Release 8 network architecture 100. As shown, 3GPP Release 8 introduced three network components in the 3GPP Core Network (EPC), namely: the evolved Packet Data Gateway (ePDG) 102, the Authentication Authorization and Accounting (AAA) Server 104, and the Access Network Discovery and Selection Function (ANDSF) 106. Certain existing network entities in the Wi-Fi network were also modified or adapted to incorporate additional functionality (such as the Mobility/Controller Gateway 108). As shown, the Wi-Fi AP 116 is a conventional IEEE 802.11n AP that conforms to the IEEE 802.11n standard. During operation, the Wi-Fi AP 116 is connected to and controlled by Mobility/Controller Gateway 108, which is integrated with the EPC via the ePDG 102. The UE 114 may also need corresponding functionality to support Client-based Mobile IP and IP Flow mobility for Wi-Fi offloading, as well the capability to support discovery, selection, association, and SIM based authentication and encryption via the Wi-Fi AP 116.

The architecture of FIG. 1 enables so-called “non-trusted access”. Specifically, the inclusion of the AAA server 104 (which is also connected to the Home Subscriber Server (HSS) 110) allows SIM-based authentication of a Wi-Fi subscriber device by means of EAP-AKA. The Packet Data Gateway (PDG) (previously introduced in Release 6) was redefined in 3GPP Release 8 as an evolved PDG (ePDG) 102. As shown, the ePDG 102 is connected directly to the Packet Data Network (PDN) Gateway (P-GW) 112 to support IP-mobility for Wi-Fi. In the architecture of FIG. 1, an user equipment (UE) 114 is configured to establish an Internet Protocol security (IPsec) tunnel between itself and the ePDG 102 (the intervening network components are not trusted entities, therefore this scheme provides non-trusted access). Since the intervening network components are not trusted, a UE 114 must establish an IPsec tunnel to the ePDG 102. This can be a significant processing burden, as the ePDG must support and maintain a separate IPsec tunnel for each UE.

3GPP Release 10 kept the network architecture 100 and introduced S2a Based Mobility over General Packet Radio Service (GPRS) Tunneling Protocol (SaMOG) which enabled “trusted” access network operation. Unlike Release 8, in Release 10, a IPsec tunnel is setup between the Wi-Fi AP 116 and the P-GW 112. This configuration alleviates large (bandwidth) IPsec tunnels at the ePDG 102; however, since the IPsec tunnel does not extend to the Wi-Fi radio interface, the air interface has to be protected by another mechanism (e.g., the HotSpot 2.0 (IEEE 802.110 standard).

Within the context of FIG. 1, various offloading algorithms can be used to address different Quality of Service (QoS) requirements for different services and IP mobility. Two features, Multi-Access PDN Connectivity (MAPCON) and IP Flow Mobility (IFOM) are specified in Release 10 for QoS based offloading; network operators may implement either scheme based on e.g., business considerations, etc.

In both MAPCON and IFOM, a unique IP address is assigned to each Protocol Data Network (PDN); each PDN is a specific service network including but not limited to: Internet, IP Multimedia Subsystem (IMS), IPTV, etc. in the current 3GPP architecture. Each PDN is further identified by an Access Point Name (APN). Moreover, all PDNs are handed to a Wi-Fi offloading network or back to the cellular network. MAPCON allows selection of access network based on the PDN QoS requirements or network load. IFOM is a more advanced version of MAPCON, as it allows a given PDN to have several IP flows, further refining and optimizing performance based on QoS. In Release 10, each PDN is associated with two IP addresses, one for cellular and one for Wi-Fi network access, allowing simultaneous access through both networks.

To complete the integration of Wi-Fi with 3GPP cellular networks, a standard automated network “Discovery”, “Selection” and “Association”, and “Policy Control” framework was required for Wi-Fi networks. The existing network architecture 100 provides the foregoing functionality with the Access Network Discover & Selection Function (ANDSF) 106 and Hotspot2.0. ANDSF provides a Client-Server based policy control solution, Hotpot2.0 provides EAP-SIM and EAP-AKA based authentication with Wi-Fi networks (e.g., discovery, selection and association with the network operator via the Wi-Fi air interface).

Exemplary Wi-Fi over Long Term Evolution (WoLTEN) Network Architecture—

Despite previous efforts, existing solutions for combining cellular and Wi-Fi ecosystems continue to suffer from a variety of problems. Specifically, the proposed 3GPP solution for cellular/Wi-Fi integration is not “holistic”; the proposed solutions are a patchwork of specialized and/or modified functional entities spread across network elements. The resulting solution is complex, incomplete, impractical, and not scalable. Even after significant investment in one of these relatively complex and expensive solutions, network operators still have to: (i) operate and maintain two different networks, and (ii) resolve different user experiences between the networks (e.g., security and QoS).

Additionally, there are other issues that these solutions do not address. For example, the Release 10 proposal (e.g., SaMOG, MAPCON, IFOM, ANDSF and HotSpot2.0) requires the Wi-Fi network to be a “trusted network”. Practical implementations will most likely need to be owned by the network operator. Such limitations (even while not expressly stated) exclude desirable features (e.g., Wi-Fi roaming, neutral host operation, etc.) and limit the deployment scenarios of Wi-Fi networks. In particular, certain independent operators (such as Boingo®) use Wi-Fi to farm out networks in the unlicensed bands.

Current solutions provide some level of integration and coexistence of cellular (e.g., 3GPP) and Wi-Fi networks; however, these solutions are often complicated, expensive and require some effort on the part of the operator to operate and maintain. In fact, within the United States of America (USA), there is only one operator (AT&T) which has adopted the aforementioned network architecture.

To these ends, various embodiments of the present disclosure are directed to methods and apparatus for hybrid access to a core network. Ideal solutions would be seamless and functionally similar in both networks (e.g., user experience, policy control, discovery, selection, association, authentication and QoS, etc.) Additionally, such embodiments should provide means for Wi-Fi roaming, Wi-Fi neutral host capabilities, and IP-mobility while also supporting network handoff for an integrated cellular/Wi-Fi network.

The current approach to Wi-Fi integration relies on incremental changes to the existing 3GPP and Wi-Fi networks e.g., by adding new functional entities while modifying some of the existing ones. In contrast, preferential solutions should build on the existing 3GPP network (i.e., where the 3GPP core network (e.g. EPC in an 4G LTE network) has no or minimal changes), instead modifying functionality at the Wi-Fi AP and UE to achieve the desired level of integration. Accordingly, various solutions are disclosed that modify Wi-Fi AP functionality, along with middle-ware software in the UE, configured to enable total Wi-Fi integration with a 3GPP network (transparently to the end user) with minimal changes in the core network.

While the following discussion is presented within the context of a 3GPP core network providing a 4G-LTE (Frequency Division Duplex (FDD)) network operating in a 3GPP approved FDD licensed-band, it is understood that the described principles may be readily applied to other network technologies by artisans of ordinary skill in the related arts, given the contents of the present disclosure. Other examples of 3GPP network technologies include, without limitation, 3G WCDMA/UMTS/HSPA, 2G and 2.5G GSM-GPRS networks, as well as FDD and TDD cellular systems.

While the following discussion is presented within the context of IEEE 802.11n Access Point (AP) technology, it is understood that the described principles may be readily applied to other network technologies by artisans of ordinary skill in the related arts, given the contents of the present disclosure. Other examples of suitable access technologies include e.g., IEEE 802.11 derivatives such as “b”, “g”, “a”, “ac”, Frequency Hopping Spread Spectrum (FHSS), Direct Sequence Spread Spectrum (DSSS) and infra-red (IR).

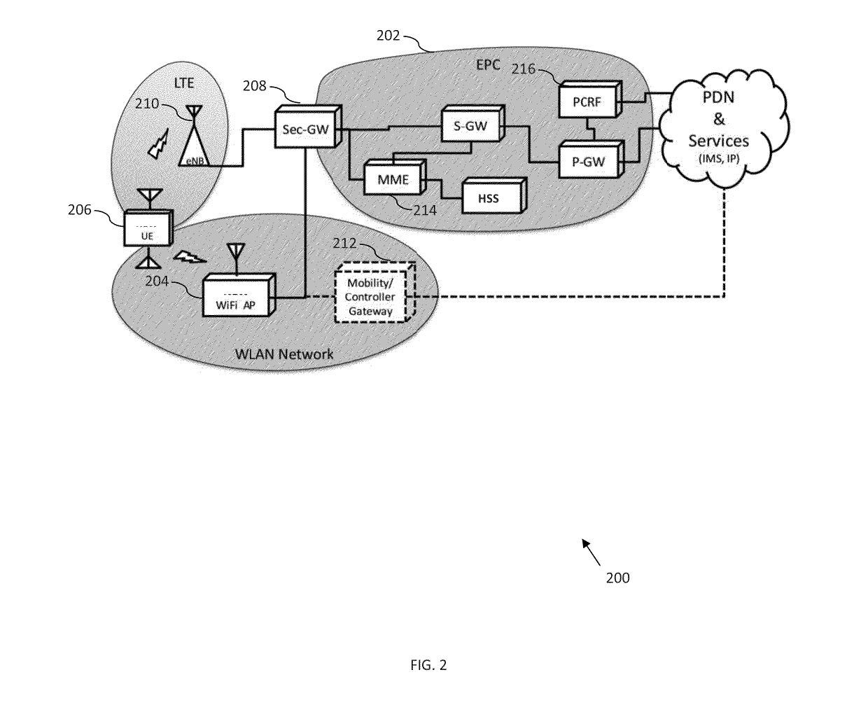

FIG. 2 depicts one exemplary embodiment of network architecture 200 hereinafter referred to as a “WoLTEN network” (Wi-Fi over Long Term Evolution (LTE) Network. In the illustrated embodiment, there is little or no modification required in the evolved Packet Core (EPC) 202; instead, software functionalities of the Wi-Fi AP 204 and UE 206 are configured to accommodate the differences in radio operation (e.g., the differences between the cellular and IEEE 802.11 operation). In the illustrated WoLTEN network, the Wi-Fi AP 204 is connected directly to the Security Gateway 208 of the EPC 202, and is treated as having the same privileges and security as an eNB 210 in the network (i.e. it is a “trusted” AP). In other embodiments (not shown), the Security Gateway 208 is directly connected to a HeNB Gateway or a Local Gateway, or equivalent secure gateway entity. In some variants, the Wi-Fi AP can also be connected to a Mobility/Controller Gateway 212 to function as a conventional Wi-Fi AP (e.g., offering support for legacy devices, etc.). Legacy operation is similar to existing proposals (e.g., see the network architecture 100 of FIG. 1, and is not further described).

During WoLTEN operation, many of the IEEE 802.11n associated lower layers (namely physical (PHY) and medium access control (MAC) layers) remain substantially the same as existing IEEE 802.11n implementations. In some embodiments, the link layer control (LLC) layer is excluded; in other variants the LLC layer may be included. However, various embodiments of the present disclosure enable LTE specific functionality above the MAC layer. Specifically, the subscriber device behaves as a logical LTE user equipment (UE) above the MAC layer; similarly, the Wi-Fi AP behaves as a logical LTE evolved NodeB (eNB) above the MAC layer. By removing the dependency upon lower layer physical functionalities from LTE higher layer functionality, the Wi-Fi offloading algorithms can freely select either radio access technology (e.g., LTE or Wi-Fi) based on relevant considerations e.g., connectivity, power consumption, data requirements, etc.

For example, as described in greater detail hereinafter, the WoLTEN network of FIG. 2 enables authentication with LTE Universal Subscriber Identity Module (USIM) (e.g., based on Extensible Authentication Protocol Authentication Key Agreement (EAP-AKA)) and as such, the Wi-Fi network can operate under an “open system authentication” mode (i.e. the Wi-Fi access does not require credentials for access to the integrated network). Since a single USIM is used for both LTE and Wi-Fi networks, the Wi-Fi offloading selection algorithm can either reside in the UE (UE-based) 206 or in the network (e.g. MME 214) or both, and can be based on a number of considerations such as load and/or radio conditions on each radio access units, Quality of Service (QoS) of the provided service, etc. In one such example, a UE-based algorithm may prefer to use Wi-Fi access, and if Wi-Fi access is not available, then the UE falls back to LTE access.

Moreover, since the Wi-Fi AP 204 is treated as an eNB entity by the WoLTEN network entities, the policy and charging rules function (PCRF) 216 can use the same policies and charging rules for eNB bearers and appropriately enabled Wi-Fi APs. In some embodiments, an operator may prefer to have different policies and charging rules for the two access units (LTE eNBs and Wi-Fi APs).

### Exemplary Wireless Station—

As described in greater detail hereinafter (see e.g., Exemplary Subscriber Device, infra), various embodiments of the present disclosure may be used in conjunction with middle-ware software located in the subscriber UE (UE-S) device. In some embodiments, the middle-ware software can be downloaded (e.g., by the user); alternatively, the middle-ware software may be pre-loaded during device manufacture. In still other embodiments, various embodiments of the present disclosure may be used in conjunction with subscriber devices which include specialized hardware to support the appropriate functionality.

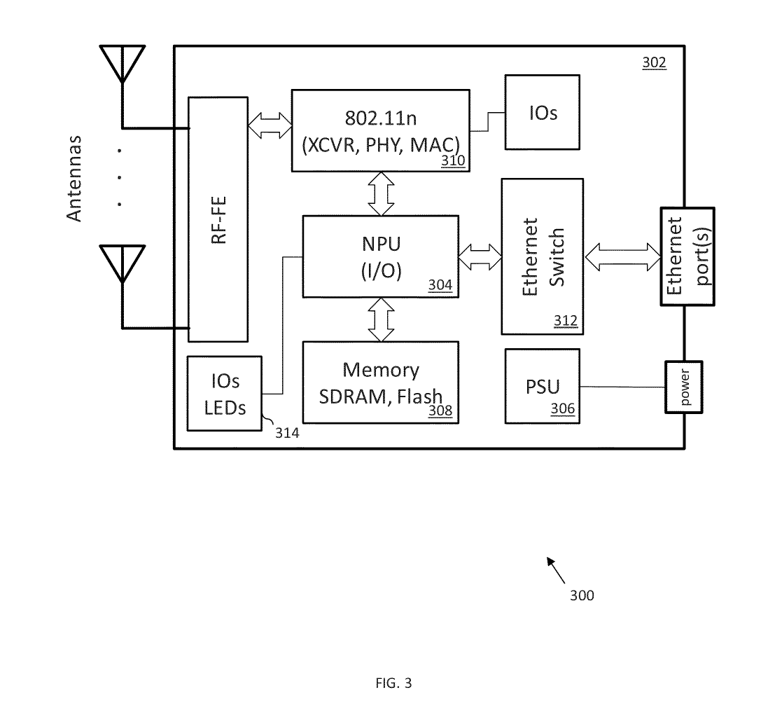

Referring now to FIG. 3, one exemplary wireless station 300 configured to provide hybrid access to a core network is presented.

In one embodiment, the wireless station 300 is a standalone device, however those of ordinary skill in the related arts will recognize that the described functionality may be incorporated in a wide variety of devices including without limitation: a base station (e.g., a Long Term Evolution (LTE) evolved Node B (eNB), etc.), a portable computer, desktop computer, etc.

The exemplary apparatus 300 includes one or more substrates(s) 302 that further include a plurality of integrated circuits including a processing subsystem 304 such as a digital signal processor (DSP), microprocessor, programmable logic device (PLD), gate array, or plurality of processing components as well as a power management subsystem 306 that provides power to the apparatus 300, a memory subsystem 308, and a first radio modem subsystem 310 and an Ethernet switch 312 and associated Ethernet port(s). In some embodiments, user input/output (10) 314 may also be present.

In some cases, the processing subsystem may also include an internal cache memory. The processing subsystem 304 is connected to a memory subsystem 308 including non-transitory computer-readable memory which may, for example, include SRAM, Flash and SDRAM components. The memory subsystem may implement one or a more of DMA type hardware, so as to facilitate data accesses as is well known in the art. During normal operation, the processing system is configured to read one or more instructions which are stored within the memory, and execute one or more actions based on the read instructions.

The processing system 304 has sufficient processing capability to support the first radio subsystem 310 and core network connectivity simultaneously. In one exemplary implementation, wireless station 300 is configured to provide additional functionality (i.e., Wi-Fi protocol stacks which are modified to support higher layer LTE protocol stacks and control software) running on the processing subsystem 304, beyond existing wireless station functionality (i.e., legacy Wi-Fi operation). In one exemplary embodiment, the processor subsystem 304 is configured to execute software for operation and control of the wireless station. One such commercial example is the Broadcom BCM4705 processor chip (which includes a processor core and a number of IOs such as GPIO, RS232 UART, PCI, GMII, RGMII as well as DDR SDRAM controller).

The illustrated power management subsystem (PMS) 306 provides power to the wireless station 300, and may include an integrated circuit and or a plurality of discrete electrical components. Common examples of power management subsystems 306 include without limitation: a rechargeable battery power source and/or an external power source e.g., from a wall socket, inductive charger, etc.

The user IO 314 includes any number of well-known IO including, without limitation: LED lights, speakers, etc. For example, in one such case, a set of LEDs can be used to indicate connection status (e.g., “green” indicates an online status, “red” indicates a malfunction or connectivity issue, etc.). In more complex embodiments, the IO may incorporate a keypad, touch screen (e.g., multi-touch interface), LCD display, backlight, speaker, and/or microphone or other IOs such as USB, GPIO, RS232 UART, PCI, GMII, RGMII.

The first radio subsystem is 310 is configured to generate a wireless network that accepts one or more subscriber devices. In one exemplary embodiment, the generated wireless network is an “open” network i.e., the generated wireless network does not require any access control measures (e.g., authentication, authorization, or accounting, etc.). While open network operation is described herein, it is appreciated that access control schemes need not be open; limited access, and closed access may be used with equal success. In fact the credentials for wireless radio subsystem 310 can be entered and set via the Ethernet switch 312 and associated Ethernet port that connects to the core network (as described in greater detail hereinafter). In some cases, the open networks may incorporate so-called “ad hoc” networking, mesh networking, etc.

The first radio subsystem is configured to generate a wireless network. In one exemplary embodiment, the first radio subsystem generates a Wi-Fi network (based on IEEE e.g., 802.11n, etc.) Other examples of suitable wireless technologies include, without limitation, Bluetooth, WiMAX, etc.

As shown in FIG. 3, there are several (2 or more) antennas to support Multiple Input Multiple Output (MIMO) operation of the first network. While not expressly shown, it is appreciated that each RF frontend includes e.g., filters, duplexers, RF switches, RF signal power level monitoring, LNA (Low-Noise Amplifier) and PAs (Power Amplifier) that may be required for the device's radio subsystem. In one exemplary embodiment, the first radio subsystem 310 includes the functionalities needed to configure and operate an IEEE 802.11n modem, including the transceiver part, PHY (physical layer) and MAC (Media Access Controller) units, as well as the associated control and operation software. One commercial example of such a RF frontend is the Broadcom IEEE 802.11n single chip product, BCM4322 or BCM4323.

The Ethernet switch 312 and associated Ethernet port(s) are configured to provide access to the Core Network (e.g., EPC 202), and potentially other network entities (e.g. eNBs, HeNBs, etc.). Other common forms of access include, for example, Digital Subscriber Line (DSL), T1, Integrated Services Digital Network (ISDN), satellite link, Data Over Cable Service Interface Specifications (DOCSIS) cable modem, etc. One commercial example of an Ethernet switch 312 is the Broadcom BCM53115 chip which provides up to five (5) Ethernet ports. In one exemplary embodiment, the wireless station is configured to directly connect to the core network of a network operator to enable the aforementioned WoLTEN operation, via the Ethernet switch 312.

### Exemplary Subscriber Device—

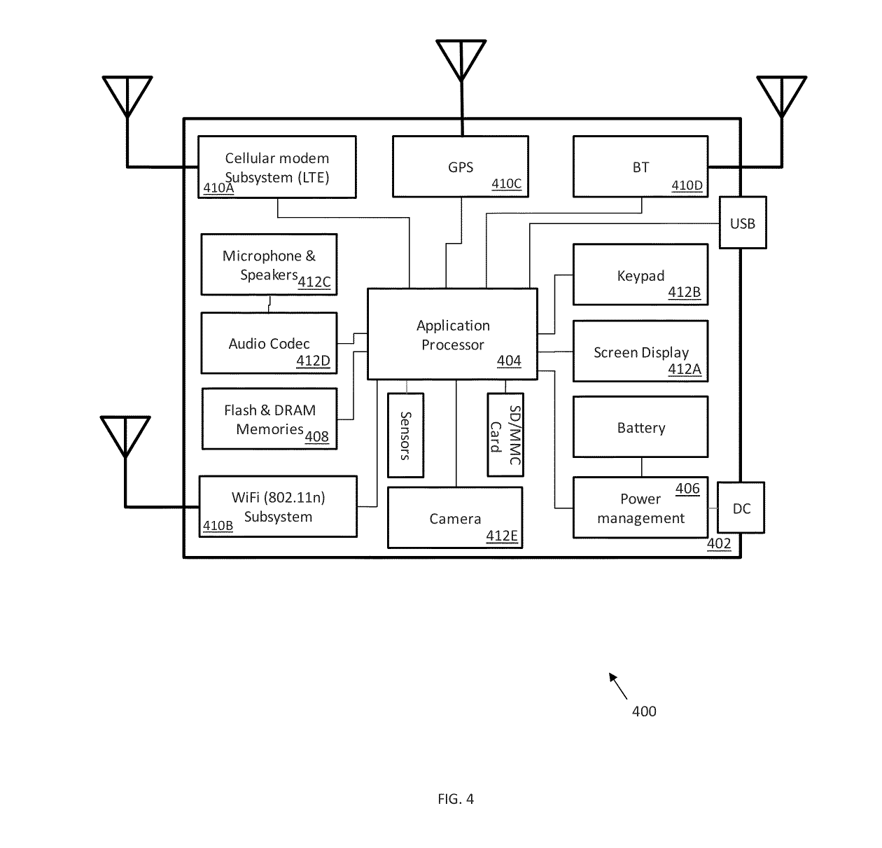

Referring now to FIG. 4, one exemplary subscriber device 400 configured to access a core network via a hybrid access scheme (via the wireless station 300 of FIG. 3). In one embodiment, the subscriber device 400 is a dedicated device, however those of ordinary skill in the related arts will recognize that the described functionality may be incorporated in a wide variety of devices including without limitation: a smartphone, portable computer, desktop computer, and even standalone devices with only one radio modem for Wi-Fi IEEE 802.11n communications, etc.

The exemplary apparatus 400 includes one or more substrates(s) 402 that further include a plurality of integrated circuits including a processing subsystem 404 such as a digital signal processor (DSP), microprocessor, programmable logic device (PLD), gate array, or plurality of processing components as well as a power management subsystem 406 that provides power to the apparatus 400, a memory subsystem 408, and one or more radio modem subsystems. As shown, the exemplary apparatus includes four (4) radio modem subsystems: a LTE cellular air-interface 410A, a Wi-Fi IEEE 802.11n air-interface 410B, GPS air-interface 410C, and a Bluetooth air-interface 410D. In some embodiments, user input/output (IO) 412 may also be present. As shown, the exemplary user input/output (IO) 412 includes: a screen display 412A, a keypad 412B, a microphone and speaker 412C, an audio codec 412D, and a camera 412E. Other peripherals may include external media interfaces (e.g., SD/MMC card interfaces, etc.) and/or sensors, etc.

In some cases, the processing subsystem may also include an internal cache memory. The processing subsystem 404 is connected to a memory subsystem 408 including non-transitory computer-readable memory which may, for example, include SRAM, Flash and SDRAM components. The memory subsystem may implement one or a more of DMA type hardware, so as to facilitate data accesses as is well known in the art. During normal operation, the processing system is configured to read one or more instructions which are stored within the memory, and execute one or more actions based on the read instructions.

As with the processing subsystem 304 of the wireless station 300 (see FIG. 3), the processing system 404 of FIG. 4 (also referred to as the “application processor”) has sufficient processing capabilities and access to memory components to at least support the Wi-Fi radio subsystems 410B and core network connectivity simultaneously. One commercial example of a processing system 404 is the Freescale iMX53 1 GHz ARM Cortex-A8 Processor or QUALCOMM Snapdragon 800.

The illustrated power management subsystem (PMS) 406 provides power to the subscriber device 400, and may include an integrated circuit and or a plurality of discrete electrical components. Common examples of power management subsystems 406 include without limitation: a rechargeable battery power source and/or an external power source e.g., from a wall socket, induction charger, etc.

The user IO 412 may include any number of well-known IO common to consumer electronics including, without limitation: a keypad, touch screen (e.g., multi-touch interface), LCD display, backlight, speaker, and/or microphone or USB and other interfaces.

Those of ordinary skill in the related arts will appreciate that the subscriber device may have multiple other components (e.g., multiple additional radio subsystems, graphics processors, etc.), the foregoing being merely illustrative.

The cellular radio subsystem 410A is configured to join a cellular network provided by a network operator. In one embodiment, the cellular radio subsystem 410A is a Fourth Generation (4G) Long Term Evolution (LTE) modem. While not expressly shown, it is appreciated that each RF frontend includes e.g., filters, duplexers, RF switches, RF signal power level monitoring, LNAs, and PAs, that may be required for the device's radio subsystem. The subscriber device 400 is associated with an identification module that verifies the subscriber device to the network operator. Generally, the identification module securely identifies the subscriber device (or subscriber account associated with the device) as being authentic and authorized for access. Common examples of identification modules include, without limitation, Subscriber Identity Module (SIM), Universal SIM (USIM), Removable Identity Module (RUIM), Code Division Multiple Access (CDMA) SIM (CSIM), etc. In some cases, the identification modules may be removable (e.g., a SIM card), or alternatively an integral part of the device (e.g., an embedded element having the identification module programmed therein). One commercial example of a cellular radio subsystem 410A is the QUALCOMM Gobi MDM9600 and its associated RF and peripheral chips.

The Wi-Fi radio subsystem 410B is configured to join a wireless network generated e.g., by the wireless station 300 of FIG. 3. In one embodiment, the wireless network radio subsystem 410B is an IEEE 802.11n compliant modem. While not expressly shown, it is appreciated that each RF frontend includes e.g., filters, duplexers, RF switches, RF signal power level monitoring, LNAs, and PAs, that may be required for the device's radio subsystem. In one exemplary embodiment, the Wi-Fi radio subsystem 410B is configured to execute software for operation and control of the IEEE 802.11n PHY (physical layer) and MAC (Media Access Controller) units, as well as the associated control and operation software. One commercial example of a Wi-Fi radio subsystem 410B is the Atheros single chip IEEE 802.11n product, AR9285.

In one exemplary implementation, the subscriber device 400 is further configured to provide additional functionality (i.e., Wi-Fi protocol stacks which are modified to support higher layer LTE protocol stacks and control software) running on the processing subsystem 404.

### Exemplary “Wi-Fi PIPE”—

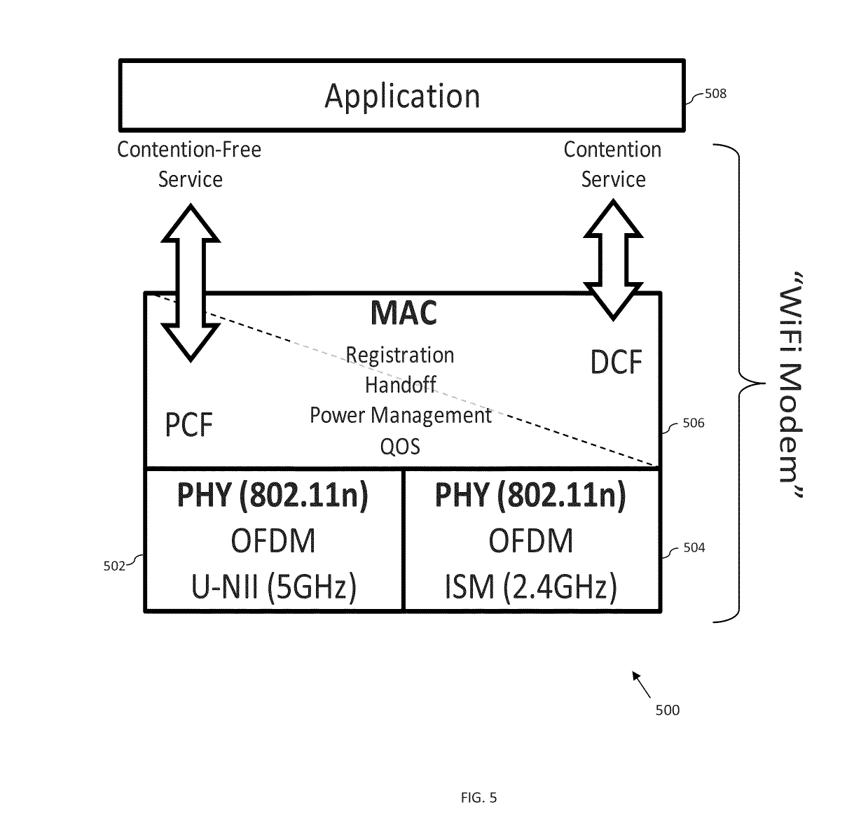

FIG. 5 illustrates a logical block diagram representing a IEEE 802.11n PHY (L1) and MAC (L2) protocol stack 500 useful in conjunction with various aspects of the present disclosure. As shown, the application software 508 operates directly above the MAC layer 506. It is appreciated that other variants may incorporate other software layers (e.g., a Logical Link Control (LLC) and/or IP layer) based on design considerations. The illustrative PHY can operate in either the U-NII band 502 or ISM band 504, or both at the same time.

The MAC layer 506 can either be set to operate in the “Contention” or “Contention-Free” mode. In contention free operation, the MAC uses a Point Coordination Function (PCF); during contention mode operation, the MAC uses a Distributed Coordination Function (DCF). Other Wi-Fi MAC functions include registration, hand-off, power management, security and Quality of Service (QoS). Where not otherwise stated herein, existing Wi-Fi components and functionality are well understood within the related arts and not discussed further.

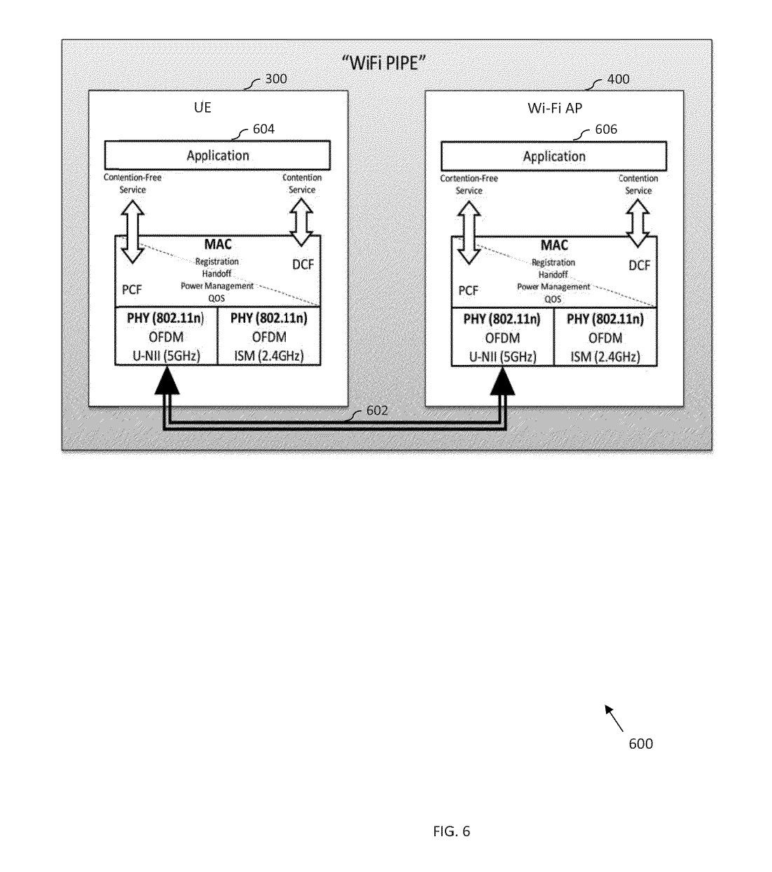

Referring now to FIG. 6, consider the exemplary wireless station 300 (e.g., as described in FIG. 3 and discussion supra) and the exemplary subscriber device 400 (e.g., as described in FIG. 4 and discussion supra). Once the exemplary subscriber device 400 enters the exemplary network agnostic wireless station 300 coverage area and registers with the open network, the end-to-end MAC connection between the subscriber device 400 and the wireless station 300 forms a “transparent” connection pipe (or access tunnel) which is termed hereafter a “Wi-Fi PIPE” 602. In some embodiments, the Wi-Fi PIPE tunnel itself is unsecure (e.g., where the hotspot behaves as an “open” Wi-Fi network), and the underlying data payloads may be protected according to existing encryption schemes used end-to-end for the cellular (LTE) network or/and at application layer, etc. such as those used over traditional untrusted networks. In other embodiments, The Wi-Fi PIPE is implemented via a closed network and incorporates native encryption, etc. (Wired Equivalent Privacy (WEP), Wi-Fi Protected Access (WPA), WPA2, etc.).

The Wi-Fi PIPE enables the two logical endpoints running a first application 604 and a second application 606 (respectively) to communicate directly without any intervening translation (i.e., data transfers are not modified). The logical endpoints are unaware of the underlying physical and data link transactions which are occurring in their respective Wi-Fi interfaces. In one exemplary embodiment, the first application 604 is coupled to the subscriber device's software stack, and the second application 606 is coupled to the wireless station's software stack (not shown). In other words, the Wi-Fi PIPE enables the subscriber device's stack (the SIM/USIM card on the subscriber device 700) to directly connect to the wireless station's stack (on the wireless station 300).

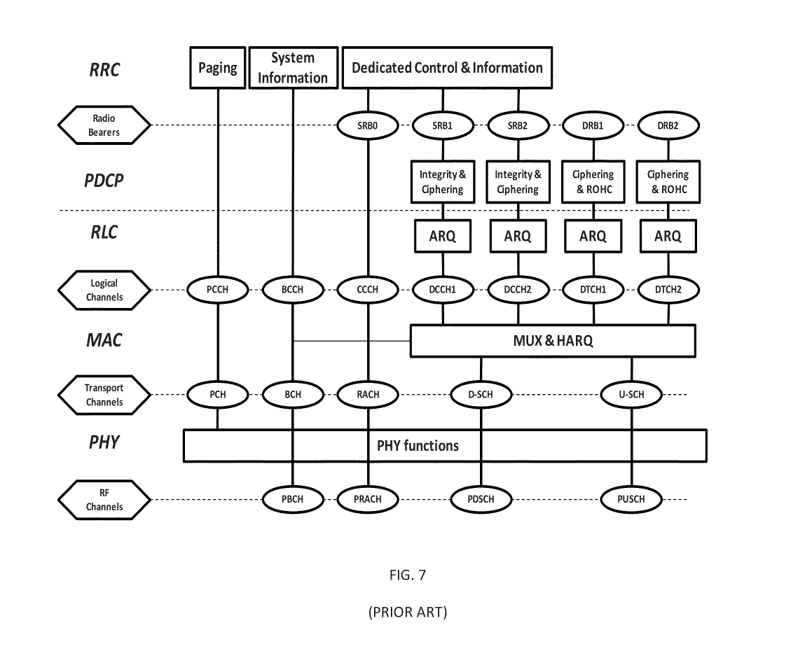

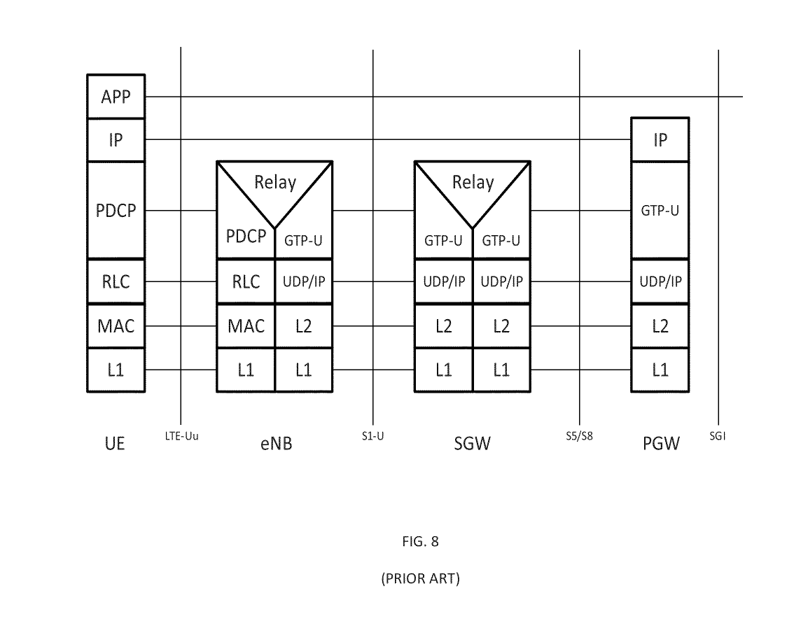

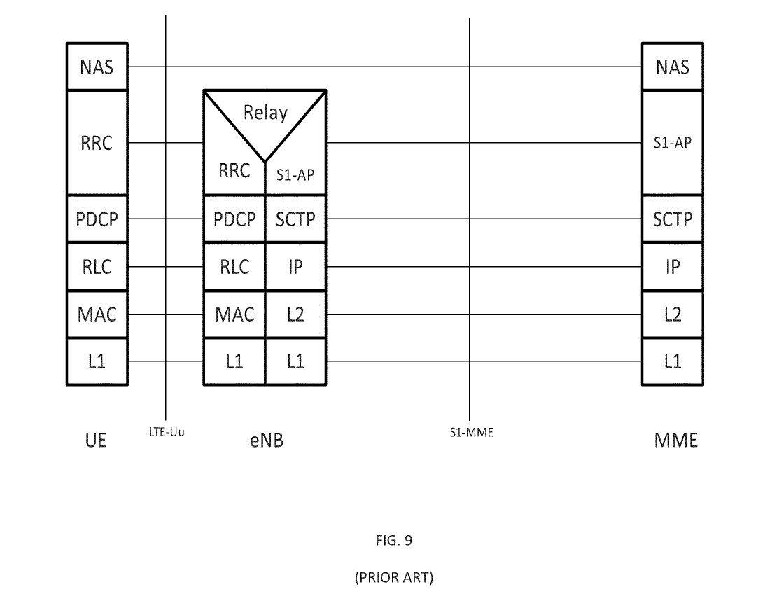

As previously noted (e.g., as described in FIG. 2 and discussion supra), the wireless station is connected to the evolved packet core (EPC) (via e.g., the Security-Gateway 208) directly. In one exemplary embodiment, the wireless station is configured to use all or some of the existing eNB LTE software structures and entities (e.g., logical channels, protocols and software stack, RRM etc) for communicating and/or interacting with the LTE EPC and UE. For example, FIG. 7 illustrates several of the Logical, Transport and Physical channels of prior art LTE radio architectures, along with the respective protocol stack layers. FIG. 8 illustrates the prior art LTE radio user-plane protocol stack that operates between the user equipment (UE), evolved NodeB (eNB), Serving Gateway (SGW), and PDN Gateway (PGW). FIG. 9 depicts the prior art LTE control-plane protocol stack for between the UE, eNB and Mobility Management Entity (MME). Yet other physical and/or logical entities (such as a Radio Resource Manager (RRM), etc.) may be useful for eNB operation, the inclusion or exclusion of such entities being within the skill of artisans in the related arts given the contents of the present disclosure.

It is relatively straightforward for the wireless station to communicate on the network side with e.g., the SGW and MME. For example, during operation, the wireless station 300 configures its Ethernet interface and executes a communication protocol as a logical eNB, thereby seamlessly integrating with the existing LTE network architecture.

Specifically, on the user-plane, the wireless station 300 appears as an eNB to the EPC and communicates with the SGW using the protocols used between eNB and SGW (e.g., the General Packet Radio Service (GPRS) Tunneling Protocol (GTPU)); communication is performed over user datagram protocol (UDP) internet protocol (IP) (via the wireless station's 300 Ethernet interface 312). On the control-plane side, the wireless station 300 communicates with the MME using the protocols used between eNB and MME (e.g., the S1-AP over Stream Control Transmission Protocol (SCTP)); communications are performed over IP. While the foregoing example is presented with respect to the wireless station's Ethernet interface, it is appreciated by those of ordinary skill in the related arts that the user-plane and control-plane communications may be performed over other interfaces (e.g., over any MAC (L2) and physical (L1) layer that is used for the backbone network between the wireless station and the EPC), given the contents of the present disclosure.

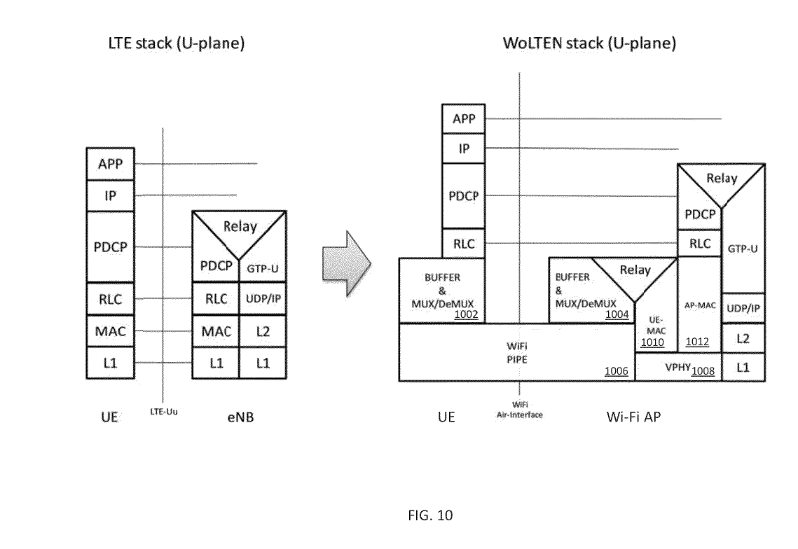

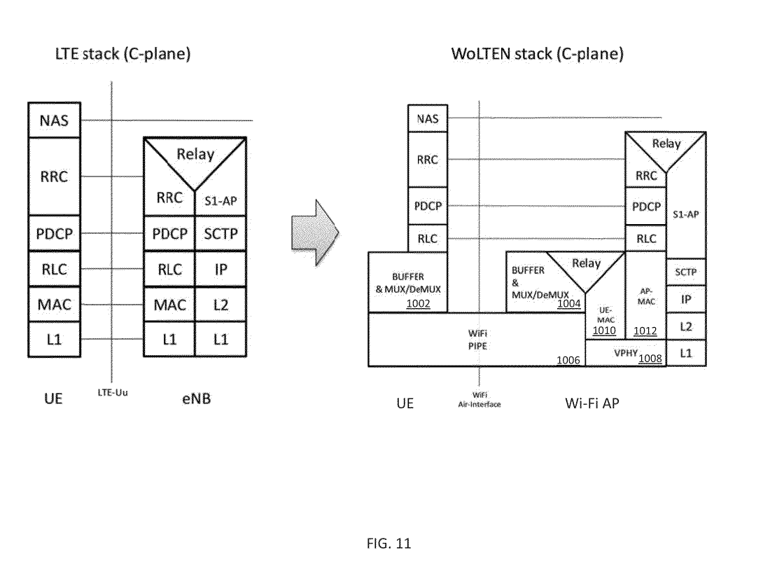

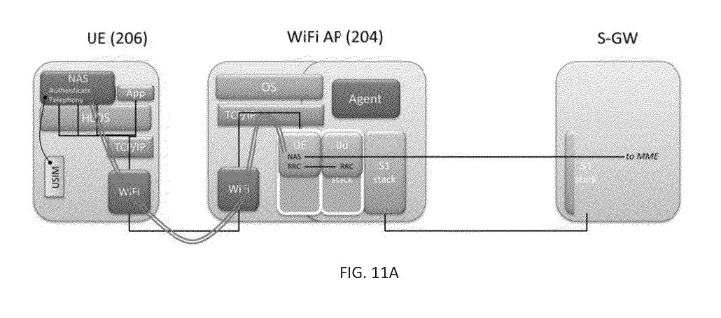

The interface between the exemplary subscriber device and exemplary wireless station (e.g., analogous to the eNB-UE interface, via the Wi-Fi air interface) requires modification to handle the differences introduced by Wi-Fi modem operation. For example, FIG. 10 illustrates one exemplary embodiment of the LTE radio user-plane protocol stack that operates between the user equipment (UE) and evolved NodeB (eNB), and the modification to support the exemplary subscriber device and exemplary wireless station, in accordance with the principles described herein. FIG. 11 illustrates one exemplary embodiment of the LTE radio control-plane protocol stack that operates between the user equipment (UE) and evolved NodeB (eNB), and the modification to support the exemplary subscriber device and exemplary wireless station, in accordance with the principles described herein.

As shown, in both FIGS. 10 and 11, the exemplary hybrid Wi-Fi PIPE protocol stack operates beneath the Radio Link Control (RLC) layer, and which has replaced the LTE MAC and L1 layers with corresponding Buffer and MUX/DeMUX assemblies (1002, 1004), Wi-Fi PIPE 1006, and virtualized PHY 1008, user equipment (UE) MAC 1010 and access point (AP) MAC 1012.

In one implementation, the Wi-Fi PIPE is coupled to First-In-First-Out (FIFO) data buffers on both sides (e.g., at the subscriber device 400 and the wireless station 300) to handle time of arrival issues (e.g., jitter) which might otherwise cause scheduling problems for the Wi-Fi PIPE or LTE operation. In multiple user embodiments, the station may incorporate multiple buffers corresponding to each user, a single buffer which is divided into multiple partitions for each user, etc.

There is one RLC entity for each radio bearer; this enables multiple radio bearers to isolate radio bearer performance. The LTE RLC is configured to disassemble (and re-assemble) data packets from (and to) the Packet Data Convergence Protocol (PDCP) layer into manageable sizes for the Wi-Fi PIPE. The LTE RLC is further configured to ensure that all received packets are in order before passing them to the PDCP layer. In the event that a packet is lost, the LTE RLC layer can perform re-transmission to recover lost packets by initiating Automatic Repeat Request (ARQ) procedures.

There is one PDCP entity per radio bearer (which ensures isolated radio bearer performance). The LTE PDCP entity is configured to provide the ciphering (and integrity) protection (over untrusted connections, such as the Wi-Fi PIPE). The LTE PDCP is further configured to provide Robust Header Compression (ROHC) which may reduce the overhead of transmitting small packets (further improving Wi-Fi PIPE performance). Finally, the PDCP entity can provide reordering and re-transmission of packets during hand-off operation.

Even though the Wi-Fi PIPE 1006 and corresponding Buffer and MUX/DeMUX assemblies (1002, 1004) enable a Wi-Fi radio link between the exemplary subscriber and the exemplary wireless station, the higher layers (e.g., the RLC, PDCP, RRM etc.) are handled with existing LTE implementations, thus the virtualized PHY 1008, UE MAC 1010 and AP MAC 1012, ensure that the LTE based higher layers are unaware of the Wi-Fi radio link operation. More directly, the UE MAC 1010 is emulated on the wireless station 300, which communicates with a virtualized PHY 1008 (VPHY) to pass the emulated MAC PDUs with minimum meditation to the wireless station's AP MAC 1012. Many LTE PHY operations are unnecessary, and thus the VPHY may effectively “bypass” or “fake” the extraneous PHY operations for correct operation of the UE MAC 1010 and AP MAC 1012. For example, procedures such as e.g., the Random Access Channel (RACH), Timing Advance (TA), etc. associated with physical layer operation are no longer needed.

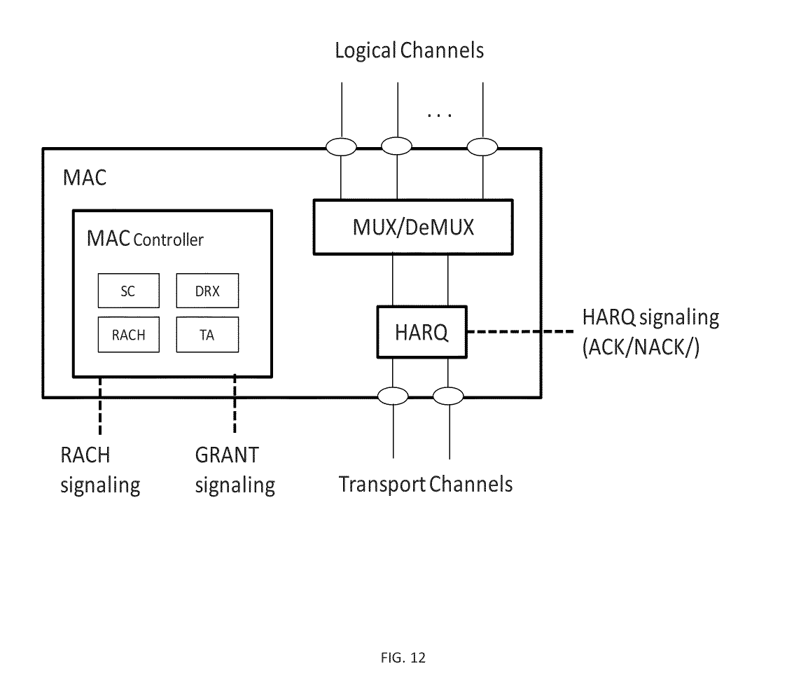

In some cases, the VPHY, UE MAC 1010 and AP MAC 1012 can be further optimized (since there is no actual physical propagation channel), as a “thin MAC” which performs the minimal formatting and translation functionality needed for successful interoperation of the Wi-Fi PIPE with the higher layers. For example, FIG. 12 depicts a conceptual architecture of the LTE MAC (UE-side) (the LTE MAC on the eNB side has similar functionality). The MAC controls operations such as RACH, TA, scheduling of channels and discontinuous reception/transmission (DRX/DTX). These functions are handled entirely within the VPHY and can be disabled or omitted (the appropriate signal or command is not performed) or “faked” (the appropriate signal or command is generated at the appropriate times to indicate success, thereby enabling processing to continue). For example, uplink and downlink resource grant signaling can be “faked” with VPHY logic that mimics physical signaling indicating that resources are always available. Downlink Hybrid Automatic Repeat Request (HARQ) can be omitted as the data packets are handled within the VPHY (which is substantially error and loss free). Similarly, uplink HARQ can be disabled as data packet errors and losses are handled before the UE MAC (e.g., by the Wi-Fi PIPE). Channel multiplexing and de-multiplexing can also be omitted as the MAC Service Data Units (SDUs) (or Protocol Data Units (PDUs) at the MAC output) can be passed directly between the UE MAC and AP MAC via the VPHY. Other MAC associated functions, including without limitation, buffer status reporting, power headroom reporting, downlink and uplink channel resource scheduling, logical channel prioritization, etc. can also be optimized and/or omitted.

The foregoing discussion of the exemplary “thin MAC” and VPHY (“Virtual” PHY) is based on the use of e.g., counters, key performance indicators (KPIs) and control information that is provided from lower layers to higher layers to ensure correct operation of the LTE protocol stack. It is appreciated that some embodiments may not need the “thin MAC” or VPHY emulation (e.g., proprietary implementations, future enhancements to existing implementations, extremely optimized implementations, specialized use cases, etc.) in which case, the RLC entities at each end can pass their frames to each other over the Wi-Fi PIPE directly.

### Other Considerations for the Exemplary Wi-Fi PIPE—

While the foregoing discussion is presented with the Wi-Fi PIPE functionality at the MAC and L1 layers, it is appreciated that other embodiments may implement similar operations at any layer of the subscriber device and/or wireless station device. For example, as illustrated in FIG. 11A, the Wi-Fi PIPE is implemented internally within a higher software layer of the protocol stack; i.e., operating at the (Transmission Control Protocol/Internet Protocol) TCP/IP layers.

Those of ordinary skill in the related arts will readily appreciate, given this disclosure, that splitting higher software layers of the protocol stack may result in changes to the underlying security architecture of the LTE system. For example, consider an embodiment that inserts the Wi-Fi PIPE within the packet data convergence protocol (PDCP) layer such that uplink encryption and downlink decryption functions are supported in the wireless station 204 (rather than at the UE 206), while uplink and downlink Robust Header Compression (RHOC) compression and decompression functions of the PDCP layer are supported in the UE 206. In such an arrangement, two issues are introduced: 1) the UE's SIM/USIM information must be provided to the wireless station 204 such that the wireless station 204 can “proxy” for the UE 206; and 2) the Wi-Fi PIPE transmissions over the radio link must be further encrypted, since the LTE encryption provided by the SIM/USIM terminates at the wireless station 204.

With regard to the “proxying”, the wireless station (e.g., Wi-Fi AP in this exemplary embodiment) 204 can incorporate one or several optional virtual (i.e., secure memory) or physical embedded or removable SIM/USIM modules within. The SIM/USIM modules may be statically programmed, or in some cases, dynamically reprogrammable. The SIM/USIM modules allow the wireless station 204 to proxy for one or more connected UEs 206 (which are serviced via Wi-Fi PIPEs). For example, one or more identity modules (such as USIM) are integrated by the wireless station 204 and “attached to” (i.e., proxy for) the one or more UE protocol stacks (including PHY layer) residing at the wireless station 204, each of which corresponds to the one or more connected UEs 206. For dynamically reprogrammable embodiments, the content of the UE's SIM/USIM (including the secret key) can then be transferred to one of the SIM/USIM modules in wireless station (Wi-Fi AP) 204. Once the content of the UE 206 SIM/USIM is replicated in the wireless station (Wi-Fi AP) 204, the entire UE protocol stack of UE 206 can be mimicked by the wireless station (Wi-Fi AP) 204 to the serving Gateway (S-GW).

Once the wireless station (Wi-Fi AP) 204 has successfully connected to the S-GW, the UE can transact data via the Wi-Fi PIPE, which connects at the TCP/IP layer (or an even higher layer) of the wireless station (Wi-Fi AP) 204 UE protocol stack.

Those of ordinary skill in the related arts will readily appreciate that the transfer of the SIM/USIM content from UE 206 to wireless station (Wi-Fi AP) 204 should be performed over a secure link. In one such implementation, the SIM/USIM content is transmitted securely over the Wi-Fi PIPE using e.g., the PGP (Pretty-Good-Privacy) protocol. PGP is a well-known public key encryption scheme useful for securely transferring data. Other encryption schemes can be used with equal success, including without limitation, symmetric key systems, chain of trust based systems, etc.

Referring now to the second issue of encrypting the exemplary Wi-Fi PIPE, since the LTE encryption terminates at the wireless station 204, the Wi-Fi PIPE between the UE 206 and wireless station 204 requires additional encryption to ensure secure transactions. In one embodiment, the Wi-Fi PIPE encryption can be based on an extension of the existing LTE encryption scheme; for example, during operation, the LTE symmetric key encryption information can be used to generate keys at both the UE 206 and wireless station 204 locations so as to extend symmetric key encryption over the Wi-Fi PIPE. In one such embodiment, the native Wi-Fi encryption algorithms and dedicated HW accelerators (Wired Equivalent Privacy (WEP), Wi-Fi Protected Access (WPA), WPA2, etc.) support key transfers based on either pre-agreed schemes, or are dynamically negotiated over-the-air. In this manner, Wi-Fi encryption algorithms and dedicated HW accelerators can be leveraged (with modifications) and/or combined with the subsequently generated and associated LTE keys so as to enable over-the-air Wi-Fi PIPE security. Finally, native LTE Non-Access Stratum (NAS) security and integrity protection can be implemented in the UE 206 in SW or HW emulation, as the data rate and volume of NAS messages are very low.

In one such embodiment, Wi-Fi PIPE encryption can be based on one or more of associated derived LTE encryption keys, and communicated (without a SIM/USIM encryption protocol) to the UE using any secure public key based protocol, such as the aforementioned PGP protocol. For example, the UE 206 transmits a public key to the Wi-Fi AP 204, which is then used by Wi-Fi AP 204 to securely send appropriate keys (e.g. one or more of the associated LTE keys, etc.) to the UE 206, after which the Wi-Fi PIPE security can be based on symmetric key encryption via the native encryption engine of Wi-Fi PIPE and available HW accelerators (Wired Equivalent Privacy (WEP), Wi-Fi Protected Access (WPA), WPA2, etc.)

Alternatively, in some embodiments, the UE 206 can support the manual entry of an encryption key, password, etc. via an appropriate software user interface (UI) application for use with the native Wi-Fi PIPE encryption engine. In some variants, manual authentication further enables access control to WoLTEN operation(s) as well. In some cases, the “manually” entered key corresponds to a pre-determined key that was set on the Wi-Fi AP 204 side (via a server or stored in one or more preset wireless stations such as Wi-Fi AP 204). In other cases, the pre-determined key may be communicated the Wi-Fi AP 204 according to an out-of-band process using a public key encryption scheme (e.g., PGP).

Those of ordinary skill in the related arts will readily appreciate that since customer billing is based on existing LTE Authentication Authorization and Accounting (AAA), the proxied Wi-Fi AP 204 SIM/USIM operation enables network operators to identify data that is transacted during Wi-Fi service i.e., off-line subscriber use of UE 206. Off-line usage metrics may be useful for, e.g., direct billing, identifying underserviced cellular coverage, identifying user habits and/or usage, determining unrealized revenue opportunities, etc.

The foregoing discussion is based on the Wi-Fi PIPE data throughput being sufficiently larger than the data throughput required by the LTE network to support all users in the coverage area. While the foregoing assumption is generally true, it is appreciated that where the LTE network operates at a faster speed than the Wi-Fi interface, the Wi-Fi PIPE may be configured to indicate the available capacity to the LTE network such that the LTE network can make appropriate adjustments to the radio bearers (e.g. resource and bandwidth allocation to each UE MAC is limited). Such scenarios may, for example, occur where the wireless station offers both cellular network connectivity and simultaneous legacy wireless station operation; the two functions may be “capped” at a certain proportion of the stations bandwidth to ensure that both functions are sufficiently supported.

### Exemplary “Wi-Fi PIPE” Software Architecture—

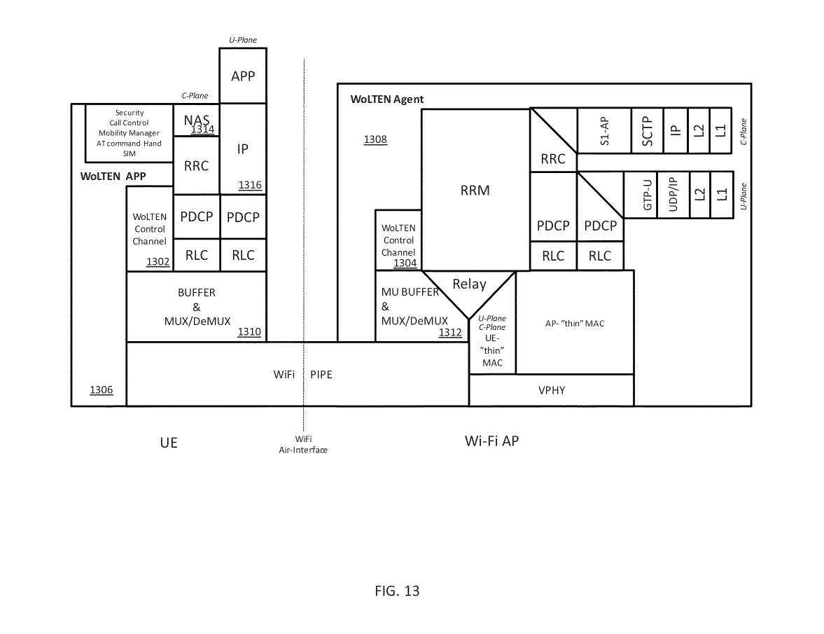

Referring now to FIG. 13, the overall protocol stack architecture (both user-plane and control-plane) for the subscriber device and the wireless station is presented. The two-way auxiliary control channels (1302, 1304) and the supporting application and agent (1306, 1308) are collectively called the Wi-Fi over LTE (WoLTEN) protocol stack.

As shown, the WoLTEN APP (application) 1306 resides in the subscriber device 400 and includes an LTE stack that supports the radio link control (RLC) layer to non-access stratum (NAS) 1314 for control-plane operations, and RLC layer to internet protocol (IP) 1316 for user-plane operations. The WoLTEN APP 1306 also includes the Buffer and MUX/DeMUX 1310, as well as the WoLTEN Control Channel 1302 and control and operation software. The counterpart WoLTEN Agent 1308 resides in the wireless station 300 and includes LTE UE MAC, VPHY, and LTE AP MAC entities which handle the counterpart control-plane and user-plane for one or more subscriber devices. In one embodiment, the WoLTEN Agent may also include other logical and/or physical entities (such as e.g., a Radio Resource Management (RRM), etc.) to handle additional functionality typically provided by a LTE eNB.

The WoLTEN APP 1306 and WoLTEN Agent 1308 communicate bi-directionally over the WoLTEN Control Channel. In one embodiment, the WoLTEN Control Channel can be opened or encrypted using a security protocol (such as PGP) to exchange keys, and to use the exchanged keys with the native encryption engine of the Wi-Fi PIPE and available HW accelerators (Wired Equivalent Privacy (WEP), Wi-Fi Protected Access (WPA), WPA2, etc.) to provide security for the WoLTEN control channel.

In one embodiment, the WoLTEN APP is a downloadable application (e.g., for purchase) and/or included in the subscriber device during manufacture. Depending on the nature of software implementation and accessibility of 3^{rd} party support for the indigenous LTE software, the WoLTEN APP can replace in whole or part, the indigenous LTE protocol stack during operation. For instance, due to security concerns, the WoLTEN APP may have its own copy of the relevant LTE protocol stack; in other embodiments, the WoLTEN APP may be configured to interface with supported LTE protocol stacks.

Referring now to the Buffer and MUX/DeMUX 1310, the Buffer and MUX/DeMUX 1310 is configured to multiplex RLC packets of different signaling radio bearer (SRBs), data radio bearers (DRBs), control-plane, user-plane, and WoLTEN Control Channel packets into a single stream for delivery via the Wi-Fi PIPE in the uplink. On the downlink, the Buffer and MUX/DeMUX 1310 is configured to buffer the incoming data and de-multiplex packets to the appropriate SRBs, DRBs, control-plane, user-plane, and WoLTEN Control Channel.

Similarly, the multiple user (MU) Buffer and MUX/DeMUX 1312 of the WoLTEN Agent is configured to multiplex different users' MAC packets (which includes SRB & DRB), and packets from their corresponding WoLTEN Control Channel into a single stream before buffering and delivering it to Wi-Fi PIPE for transmission to the subscriber. On the uplink, the MUX/DeMUX 1312 is configured to buffer and demultiplex packets (from multiple users) delivered via the Wi-Fi PIPE, before passing it to respective LTE MAC and PHY entities corresponding to the subscriber. Every subscriber attached to the network via the WoLTEN agent has a unique instance of a corresponding WoLTEN protocol stack.

### Methods—

The exemplary Wi-Fi PIPE between the WoLTEN APP 1306 and WoLTEN Agent 1308 is self-contained. The Wi-Fi link is managed without input from external entities. The WoLTEN APP and WoLTEN Agent communicate bi-directionally over the WoLTEN Control Channel and are responsible for:
a) Wi-Fi PIPE management when in the coverage area of AP 300, which further may include:
   a. configuration of the Wi-Fi PIPE, monitoring and maintaining the operation of the Wi-Fi PIPE according to radio link performance; and
   b. acquisition and configuration of an LTE session with the Evolved Packet Core (EPC) network that is configured to provide sufficient throughput for the Wi-Fi PIPE;
b) LTE link management (to assist in selection between LTE and Wi-Fi interfaces) which generally includes:
   a. system information transfer;
   b. paging channel operation;
   c. cell measurement and responsive cell reselection and hand-off procedures;
   d. radio resource control (RRC);
   e. security, integrity, access control (e.g., via SIM);
   f. call control;
c) mobility control; and
d) WoLTEN session initiation;
   a. discovery, initiation and configuration of the WoLTEN session (e.g., for hotspots which support both WoLTEN and legacy operation).

Yet other physical and/or logical entities may be useful for operation, the inclusion or exclusion of such entities being within the skill of artisans in the related arts given the contents of the present disclosure.

In more detail, the Wi-Fi PIPE management controls the wireless connectivity between the subscriber device and wireless station. In one embodiment, Wi-Fi hotspot functionality is based on legacy components operating according to e.g., existing IEEE 802.11n specifications; in other embodiments, the Wi-Fi hotspot functionality may be integrated with the WoLTEN APP and/or WoLTEN Agent to optimize performance for use specific to the Wi-Fi PIPE. For example, the WoLTEN Agent can monitor the performance of the LTE network connectivity and use the monitored performance to inform Wi-Fi PIPE operation to e.g., improve resource allocation of users, etc. By coordinating channel and bandwidth assignments, the WoLTEN Agent can reduce the amount of buffering and/or provide better quality (e.g. low latency and low jitter) links configured for services such as VoLTE (Voice over LTE) or VoIP (Voice over IP). It is appreciated that certain operations may not directly affect the radio link (e.g., Wi-Fi registration, Intra-Wi-Fi hand-off, Wi-Fi Power management and Wi-Fi QoS, etc.); depending on implementation, these features can be handled within either legacy components and/or the WoLTEN APP/Agent.

In one embodiment, LTE network connectivity is based on legacy components operating according to e.g., existing LTE specifications; in other embodiments, the LTE link functionality may be integrated with the WoLTEN APP and/or WoLTEN Agent to optimize performance for use specific to the Wi-Fi PIPE. As previously alluded to, the performance of the LTE link can be monitored to improve Wi-Fi PIPE operation. Similarly, operations which may not directly affect the LTE performance may be handled by legacy components, or incorporated within the WoLTEN Agent and/or WoLTEN APP. Common examples include, without limitation: LTE network acquisition (selection and reselection), Authentication, Encryption, Integrity Protection, Call Control (call/session set-up/tear-down), Mobility (Intra and Inter LTE hand-off), etc.

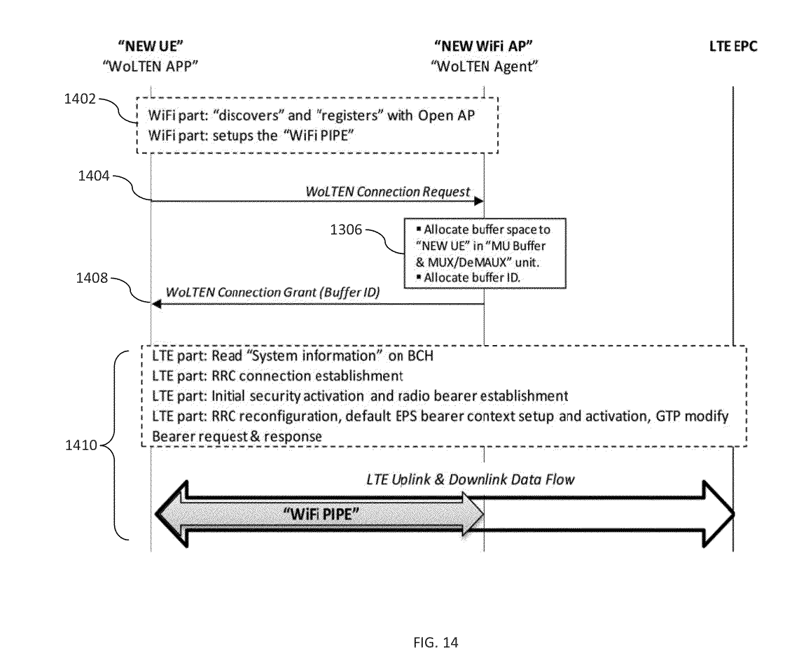

With regards to mobility management, one embodiment of a generalized process for discovery, initiation and configuration of a session is depicted within FIG. 14. As shown, the WoLTEN APP and/or WoLTEN Agent are configured to discover, initiate and configure the WoLTEN session and Wi-Fi PIPE.

At step 1402 of the process 1400, a subscriber device discovers an enabled wireless network. The subscriber device determines whether the wireless network supports WoLTEN operation. Common examples of discovery include without limitation: decoding control broadcasts, direct inquiry, etc.

In some variants, the wireless network is an “open” network. Open networks do not have restrictive access controls (e.g., authentication, authorization, etc.). In other networks, the network may be closed, partially limited, etc. For example, the subscriber device may be required to prompt the user for a password or to press a button on the wireless station, etc. In still other cases, the subscriber device may be allowed access via out-of-band procedures (e.g., allowed by an administrator, etc.). Various other suitable schemes are appreciated by those of ordinary skill within the related arts, given the contents of the present disclosure.

At step 1404, when the subscriber device determines that the wireless network supports WoLTEN operation, the WoLTEN APP attempts to establish an access tunnel (or Wi-Fi PIPE session) between the subscriber device and a network operator via the wireless station. In one embodiment, the access tunnel includes a Wi-Fi PIPE between the subscriber device and the wireless station. In one such example, a WoLTEN APP (or WoLTEN Agent) transmits a WoLTEN Connection Request via a WoLTEN Control Channel; the Connection Request includes information pertinent to connection establishment. Common examples of information include e.g., software version, a list of Wi-Fi and LTE neighbors, etc.

At step 1406 of the process 1400, responsive to reception of the Connection Request, the WoLTEN Agent determines whether a WoLTEN connection can be established. In some cases the WoLTEN Agent may be unable to support the connection request due to resource limitations (e.g., lack of memory, insufficient processing power, unable to access network operators, etc.). If the WoLTEN Agent can support the connection request, then the WoLTEN Agent allocates or reserves memory for the data stream buffering corresponding to the subscriber device. In one embodiment, a portion or partition of the MU Buffer & MUX/DeMUX buffer of the WoLTEN Agent is reserved and issued a Buffer ID (Handler). The Buffer ID is provided to the WoLTEN APP, and thereafter the subscriber device WoLTEN APP will use the Buffer ID to access/modify its corresponding WoLTEN connection (the WoLTEN Agent may be handling multiple distinct subscribers simultaneously).

At step 1408, if the WoLTEN connection request was successful, then the WoLTEN Agent provides the connection parameters back to the WoLTEN APP via a WoLTEN Connection Grant. In one implementation, the connection parameters include the Buffer ID. Other common examples of connection parameters may include e.g., quality of the connection, maximum data rate and/or throughput, minimum data rate and/or throughput, latency, other connection limitations (e.g., QoS), etc.

At step 1410, thereafter the subscriber device can transact data via the WoLTEN connection. More generally, the subscriber device can perform “access tunneled” LTE operation e.g., system acquisition, connection establishment, activation, radio bearer establishment, and data flow, etc.

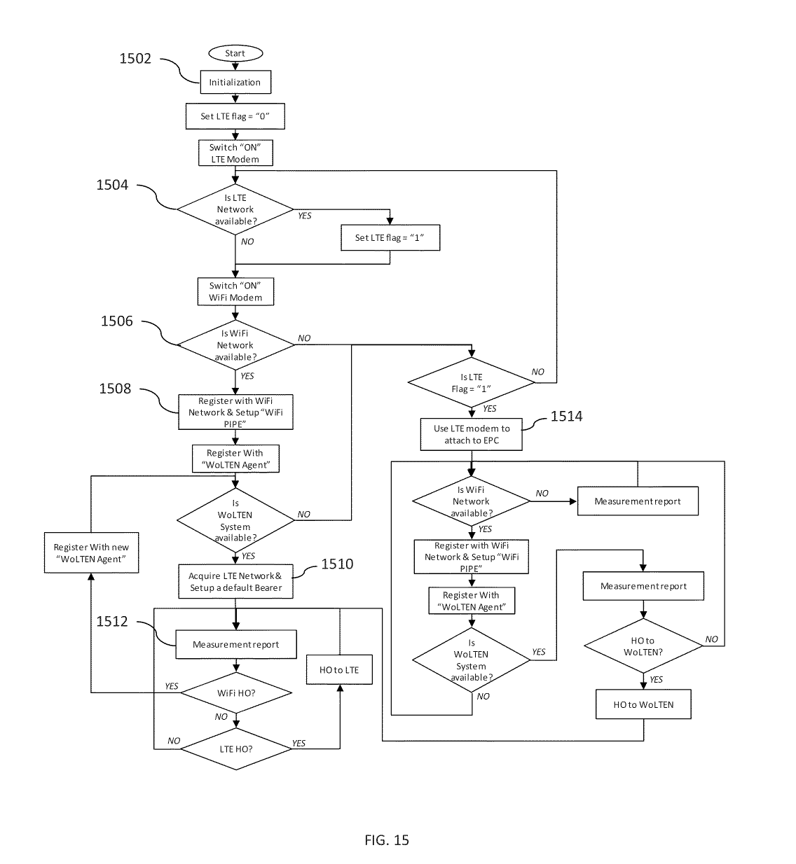

FIG. 15 illustrates an exemplary logical flow for initiating a WoLTEN connection of one exemplary embodiment of a WoLTEN APP executed on a subscriber device platform.

At step 1502, when the subscriber device is first Powered ON or Reset, the WoLTEN APP initializes and sets its internal variables and flags to default values (e.g. “LTE Flag” is reset to “0” to indicate that no LTE network is currently available).

At step 1504, after initialization, the WoLTEN APP enables the LTE Modem and searches for available LTE eNBs and networks. Upon detecting a desired network and eNB, the WoLTEN APP sets the “LTE Flag” to “1” to indicate that LTE network access is available.

Before attaching to the LTE network, the WoLTEN APP attempts to search for a Wi-Fi network to attempt WoLTEN operation. Generally, WoLTEN is preferable to LTE access as WoLTEN operation consumes less power and/or supports higher data rates, etc. It is appreciated that certain other implementations may incorporate different priority schemes.

At step 1506, the WoLTEN APP enables a Wi-Fi modem and looks for nearby Wi-Fi APs. In some cases, the WoLTEN APP may have a preferred access mode that is configured specifically to find wireless stations.

At step 1508, if a Wi-Fi Access Point (AP) is found, the WoLTEN APP will register with it. In simple implementations, the Wi-Fi AP is operating in an “open” mode. If the WoLTEN APP cannot register with the Wi-Fi AP then the WoLTEN APP proceeds as if no Wi-Fi AP was found. Closed Wi-Fi APs may still be accessible via an alternative access scheme (described subsequently).

At step 1510, if the WoLTEN APP has successfully registered with the Wi-Fi AP, then the WoLTEN APP will interrogate the AP to find out whether or not it has a suitable WoLTEN Agent. In one embodiment, the interrogation includes a WoLTEN Connection Request/WoLTEN Connection Grant transaction. If the WoLTEN interrogation is successful then the “WoLTEN APP” can continue with LTE network acquisition/registration via the Wi-Fi PIPE, using the wireless station's network connection (e.g., Ethernet).

Periodically during the WoLTEN connection, the WoLTEN APP will measure performance to determine whether a better Wi-Fi AP or LTE eNB is available. In one embodiment, the subscriber device may periodically power its own LTE cellular interface to perform appropriate measurements. These measurements are reported to the LTE network; the LTE network may responsively cause a hand-off (HO). Exemplary measurements which are useful for HO may include, without limitation: Received Signal Strength Indicator (RSSI) signal level measurements, Signal to Noise Ratio (SNR), Bit Error Rate (BER), etc. Other useful information may include e.g., the neighbor list for LTE eNBs which is based on measurements made by the subscriber device's LTE PHY.

Referring back to step 1514, when no Wi-Fi network is available but one or more LTE networks are, the WoLTEN APP will proceed to use LTE network, while continuously looking for a WoLTEN enabled Wi-Fi AP.

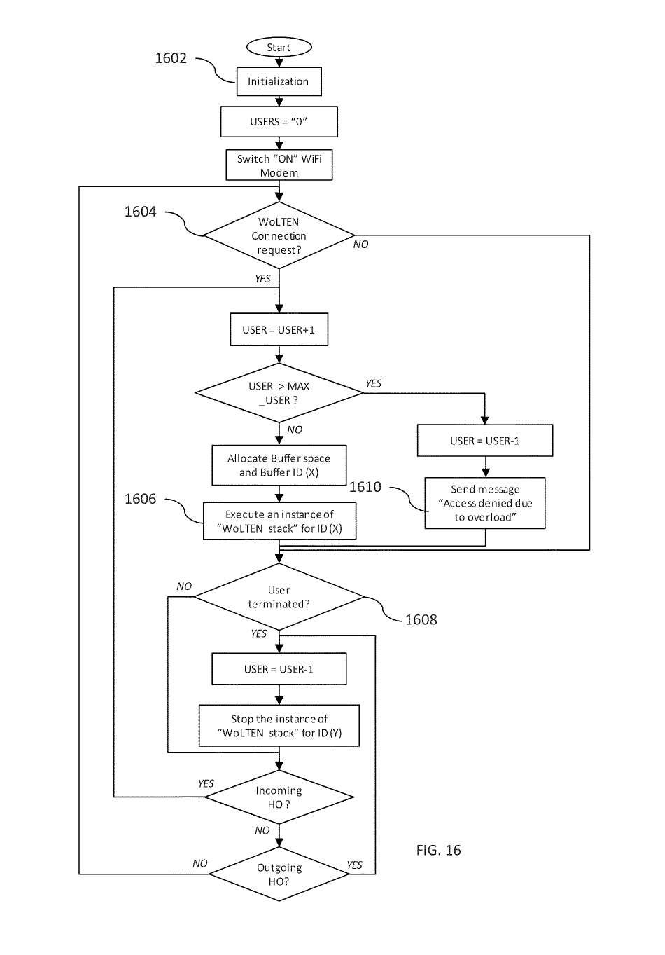

FIG. 16 illustrates a logical flow for initiating a WoLTEN connection of one exemplary embodiment of a WoLTEN Agent executed on a wireless station.

At step 1602, when the wireless station is first Powered ON or Reset, the WoLTEN APP initializes and sets its internal variables and flags to default values (e.g. “USER” set to “0” to indicate that no users are currently being served, and MAX_USER set to “1” for single user operation), and proceeds to switch ON the Wi-Fi Modem.

At step 1604, responsive to receiving a WoLTEN Connection Request message, the WoLTEN Agent determines whether or not the Connection Request can be serviced. In one exemplary embodiment, the WoLTEN Agent increments the USER register and verifies that the number of users has not exceeded the maximum allowed number of users. If the maximum allowed number of users is not reached, then the WoLTEN Agent proceeds to allocate buffer space on a MU Buffer & MUX/DeMUX buffer and allocate a Buffer ID to the WoLTEN APP, which is communicated to the WoLTEN APP with a WoLTEN Connection Grant. During subsequent transactions, the WoLTEN APP is expected to use the Buffer ID every time it sends a message; in some implementations, the Buffer ID may be extracted by association with a Wi-Fi user ID (e.g. MAC address) of the incoming packets).

Otherwise, if the Connection Request cannot be serviced (e.g., the maximum number of users is reached), then the new user is denied access. In some cases, an informational message is sent to inform them of the failure (e.g., system overload).

At step 1606, the WoLTEN Agent launches an instance of the WoLTEN protocol stack for the new user (Each WoLTEN APP requires an instance of a WoLTEN protocol stack).

Periodically, the WoLTEN Agent checks to see whether or not a user has terminated a connection (step 1608). When a user has terminated a connection, the WoLTEN Agent decrements the USER register and stops the corresponding WoLTEN protocol stack instance associated with the corresponding WoLTEN APP.

Incoming hand-offs (HO) have a similar flow to adding a new user (see step 1604), whereas outgoing hand-offs are similar to user termination (see step 1608).

### SIM-less Variations—

Various embodiments of the present disclosure are directed to user equipment (UE) that interface to a local subscriber identity module (SIM, USIM, UICC, CSIM or RUIM). However, alternative implementations may offload SIM functionality in so-called SIM-less operation. As used herein, the term ‘SIM-less’ refers generally and without limitation to the absence of a local subscriber identity module (SIM, USIM, UICC, CSIM or RUIM) with respect to e.g., software, hardware, and/or firmware operation.

In a first such implementation, a SIM/USIM module that “proxies” a portion of the UE protocol stack (for an associated UE 206) is integrated within the Wi-Fi AP 204. As used in the present disclosure, the term “proxy” refers generally to the ability of a wireless station (or other intermediary node) to perform as an authorized substitute for a mobile device, with respect to a larger network. In one such implementation, the PDCP layer has been functionally split and is managed by the WoLTEN protocol stack of a Wi-Fi PIPE. In order to support the security requirements of the Authentication and Encryption and Integrity Protection of the PDCP layer, the proxy UE protocol stack that is executed at the Wi-Fi AP 204 includes all of the subordinate software layers (e.g., all of the LTE UE layers up to and including PDCP); the remaining software layers in this implementation reside at the UE 206 on the user-plane (which is operating in a SIM-less mode). Furthermore, in the exemplary implementation, the control-plane is terminated at the Wi-Fi AP 204.

Those of ordinary skill in the related arts, given the contents of the present disclosure, will readily appreciate that other configurations may be used with equal success. For example, an alternative variant may dispose the Wi-Fi PIPE inside the PDCP layer, such that uplink encryption and downlink decryption functions are supported in the wireless station 204, while uplink and downlink Robust Header Compression (RHOC) compression and decompression functions of PDCP layer are supported in the SIM-less UE. Under such configurations the LTE encryption/decryption is handled at the Wi-Fi AP 204, thus additional encryption is desired to protect the Wi-Fi PIPE transmissions, as the data stream between the SIM-less UE and wireless station 204 is no longer protected. As previously noted supra, The Wi-Fi PIPE encryption can be based for example on the one or more associated/derived LTE encryption keys, which can be communicated to the SIM-less UE via e.g., PGP security protocols.

In a second implementation, an external subscriber identity module (SIM/USIM) is coupled to the SIM-less UE via an available wired (e.g., USB) or wireless (e.g., Bluetooth) I/O port. The external SIM/USIM natively is coupled to the LTE stack of the SIM-less UE.

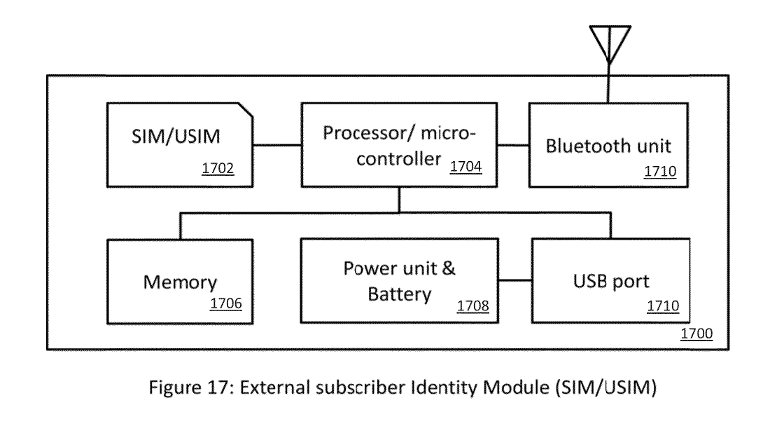

FIG. 17 illustrates one such exemplary configuration of the external module 1700 including: a SIM/USIM 1702, a processor 1704, a non-transitory computer-readable memory 1706, a power unit (e.g., battery) 1708 and an I/O communications module (such as Bluetooth, USB, etc.) 1710. The I/O communications module the USIM module 1700 and the SIM-less UE can be secured via e.g., bi-directional public key-private key encryption, symmetric key encryption (e.g., manually entered key or pre-installed key).

During normal operation, the external module 1700 holds the LTE evolved Packet System (EPS) KASME (Key Access Security Management Entity) encryption key that enables the initial authentication between the external module 1700 and the mobility management entity (MME) of the LTE network, via the SIM-less UE. After the initial authentication process is completed, the subsequent LTE EPS derived keys (e.g., KeNB (evolved NodeB Key), CK (Cipher Key) and CI (Integrity Check)) are securely communicated from the external module 1700 to the SIM-less UE using an existing secure link (e.g., via PGP encryption). The subsequent encryption/decryption can be handled at the SIM-less UE using, for instance, a software emulated implementation of the remaining LTE security algorithms. Alternatively, for implementations where the PDCP layer of the SIM-less UE is proxied by the Wi-Fi AP 204, the native Wi-Fi encryption engine (Wired Equivalent Privacy (WEP), Wi-Fi Protected Access (WPA), WPA2, etc.) can utilize the LTE EPS derived keys (e.g., KeNB, CK and CI) at the Wi-Fi AP 204 and SIM-less UE to secure the Wi-Fi PIPE transmissions. With regard to non-access stratum (NAS) security and integrity protection, these functions can be implemented in the SIM-less UE, such as in software, as the data rate and volume of NAS messages are very low.

Still other implementations may transfer the LTE EPS derived keys from the Wi-Fi AP 204 to the UE 206 using a secure protocol. Additionally, some variants may use a NULL encryption (i.e., no encryption) for the user-plane, but use a software based security for LTE encryption/decryption and integrity checking at the SIM-less UE. In such variants, the native Wi-Fi encryption engine (Wired Equivalent Privacy (WEP), Wi-Fi Protected Access (WPA), WPA2, etc.) may be used in conjunction with the one or more associated/derived LTE symmetric keys for the user-plane encryption/decryption within the SIM-less UE.

In a further variant, a SIM-less UE “piggy-backs” on a connected UE 206 identity module (e.g. SIM/USIM). For example, consider a scenario where a UE with a SIM/USIM is already associated to the LTE network via the same Wi-Fi AP 204. If the associated UE is connected in its RRC IDLE mode, the WoLTEN Application can trigger a state transition to the RRC CONNECTED mode (i.e., initiating an active session). Thereafter, the SIM-less UE can request to share (or piggy back) the active RRC connection.

In some cases, the Wi-Fi AP 204 may verify that the SIM-less UE is authorized to piggy-back on the previously associated UE; common authorization schemes include without limitation, password based schemes, user prompt (i.e., the user of the associated UE is prompted to add the SIM-less UE), etc. Under piggy-backed variants, both NAS and RRC operation can be controlled by the Wi-Fi AP WoLTEN Agent (running on either the associated UE and/or the SIM-less UE) via the WoLTEN App, through the dedicated WoLTEN control channel.

If the piggy-backed operation is authorized, the Wi-Fi AP 204 may support the SIM-less UE according to multiple different schemes. In a first scheme, if dual-IP stack UEs are supported by the LTE network, then the Wi-Fi AP 204 requests a new IP address (from the LTE evolved packet core (EPC)) for the same USIM entity. After acquiring the second IP address, the Wi-Fi AP 204 can set up an additional bearer for the second IP address intended for the SIM-less UE, and create a second LTE UE stack (up to the IP layer). The second LTE UE stack tunnels the appropriate IP packets over the Wi-Fi PIPE to the SIM-less UE. As previously noted, the Wi-Fi PIPE security can be implemented in a variety of schemes. The WoLTEN network for the associated UE is completely independent of the network for the SIM-less UE.

Alternatively, the associated UE and the SIM-less UE may use the same LTE UE stack to service both IP addresses which are subsequently relayed by the Wi-Fi PIPE. In such implementations, the IP addresses are used by the associated UE and the SIM-less UE via Wi-Fi access. More directly, both sets of IP packets are transmitted over the Wi-Fi PIPE to the associated UE and the SIM-less UE. The associated UE and the SIM-less UE both internally determine which packets are addressed to them.

In a second scheme, the piggy-backed operation is supported over the associated UE's IP address (another IP address is not provisioned). In one such implementation, the WoLTEN network uses the same bearer for both the SIM-less UE and the associated UE but with unique port numbers for the SIM-less UE and the associated UE. Thereafter, IP packets can be routed to the intended UE (SIM-less UE or the associated UE) over the Wi-Fi PIPE. Alternatively, in another such implementation, the WoLTEN network uses unique port numbers for the SIM-less UE and associated UE, and sets up additional bearers for the SIM-less UE. In this manner, the SIM-less UE has a separate protocol stack up to the IP level at Wi-Fi AP 204, the lower levels handle the selection and transmission of the appropriate IP packets over the Wi-Fi PIPE to SIM-less UE and associated UE.

During piggy-backed operation, the Wi-Fi PIPE security can be seeded with the associated UEs cryptographic information, etc. as described supra. For example, the Wi-Fi PIPE security may be implemented based on a PGP protocol to exchange keys used with the native Wi-Fi encryption algorithms (Wired Equivalent Privacy (WEP), Wi-Fi Protected Access (WPA), WPA2, etc.). It is also possible to use a NULL encryption for the user-plane, but use a software implementation for LTE encryption/decryption and Integrity checking at the SIM-less UE, while using the native Wi-Fi encryption engine (Wired Equivalent Privacy (WEP), Wi-Fi Protected Access (WPA), WPA2, etc.) in conjunction with one or more associated LTE symmetric keys for the user-plane encryption/decryption within the SIM-less UE. Still other implementations may handle the bearer associated with the associated UE differently and/or with a different stack partitioning from the SIM-less UE.

In another variant, the SIM-less UE uses a virtual identity module to store and/or manage one or more SIM/USIM protocols. In this option, the KASME key of a USIM, along with pre-installed authentication and key generation algorithms are received and stored (manually, via an out-of-band software process (such as a user application), via an external SIM/USIM module, etc.) in a secure memory area at the SIM-less UE. After authentication, the subsequent encryption and/or decryption can be handled by the SIM-less UE using e.g., any of the aforementioned processes. For example, security may be handled via a software implementation of LTE algorithms, and/or the native Wi-Fi encryption engine with one or more generated LTE keys for over-the-air security of Wi-Fi PIPE. As previously noted, since the LTE keys are symmetric at the Wi-Fi AP 204 and the SIM-less UE, these keys can be independently generated at both ends of the Wi-Fi PIPE. Alternatively, the LTE keys can be transferred from Wi-Fi AP 204 to SIM-less UE using a PGP protocol. It is also possible to use a NULL encryption for the user-plane, and a software implementation for LTE encryption/decryption and Integrity checking at the SIM-less UE, while using the native Wi-Fi encryption engine (Wired Equivalent Privacy (WEP), Wi-Fi Protected Access (WPA), WPA2, etc.) in conjunction with one or more associated LTE symmetric keys for the user-plane encryption/decryption within the SIM-less UE. Additionally, some implementations may perform NAS security and integrity protection in the SIM-less UE software as the data rate and volume of NAS messages are very low.

It is also possible to place all or most of the UE 206 stack, for example including NAS layer, within the access point (e.g., Wi-Fi AP 204), as shown in FIG. 18. In this example, part of the UE 206 NAS that is responsible for Authentication is placed in the UE 206 App (which can be downloadable), connected to the other parts of the UE 206 NAS residing within the Wi-Fi AP 204 by the dedicated control channel that exists between the UE 206 App and the Wi-Fi AP 204 Agent. Therefore, the Agent in Wi-Fi AP 204 has to have a connection to the NAS parts residing in the UE 206 protocol stack residing in Wi-Fi AP 204. Equally, UE 206 App has to have a connection to the part of the NAS that is residing within the UE 206. In fact it is possible to keep the entire UE 206 NAS entity within the Wi-Fi AP 204, and using the control channel that exists between the UE 206 App and the Wi-Fi AP 204 Agent to connect the USIM API to the UE 206 NAS which is in the Wi-Fi AP 204 Agent.

In one embodiment, the UE further includes a user interface application which resides above the high level operating system. In one variant, the user interface application is configured to emulate in software, traditionally hardware-based elements for processing Voice over LTE (VoLTE) telephone calls and LTE messaging. In one exemplary embodiment, the user interface application incorporates one or more software based: voice codecs, echo cancellation, dialing pad, etc. In one such variant, the user interface application is configured to connect a VoLTE call via the aforementioned WoLTEN network connection.

While the foregoing exemplary implementations and variants for SIM-less operation describe the various operations performed by the associated UE, SIM-less UE, and Wi-Fi AP 204, those of ordinary skill in the related arts, given the contents of the present disclosure, will additionally recognize that many LTE-specific functions are obviated by such operation, and thus can be ignored, “pruned”, or otherwise optimized. For example, in one such embodiment, the UE 206 protocol stack residing in Wi-Fi AP 204 and the eNB protocol stack residing in Wi-Fi AP 204 can greatly reduce PHY, MAC, RLC and PDCP software transactions, as these software layers are useful only for LTE radio operation (and thus is subsumed by the Wi-Fi PIPE operations). Those of ordinary skill in the related arts will appreciate that vestigial versions of these layers may be executed to ensure correct end-to-end operation of the LTE procedures, and/or to allow the remaining portions of the software stack to operate with minimal impact.

For example, LTE RRC functionality on both UE and eNB software stacks can be minimized since e.g., there is no LTE radio, and thus LTE handoff and measurement operations are obviated. In another such example, PDCP ROHC and/or internal encryption are unnecessary, thus a NULL encryption can be used for user plane operations. For control plane operations, any encryption and integrity protection can be performed in software for both the UE 206 and Wi-Fi AP 204 sides. As previously described, LTE keys generated on both UE 206 and Wi-Fi AP 204 sides can be used in the Wi-Fi native encryption engine to encrypt the user and control plane data between UE 206 and Wi-Fi AP 204. The dedicated control channel that exists between the UE 206 App and Wi-Fi AP 204 Agent can be either open (un-encrypted) or encrypted by PGP key exchange between the App and Agent.

Myriad other schemes for implementing hybrid access to a core network will be recognized by those of ordinary skill given the present disclosure.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

What is claimed is:

1. A method for wireless communications utilizing at least a first communications system and a second communications system, the first communications system having at least a first node and a second node in communication with each other, the method comprising:
executing a first portion of layers of a first protocol stack within the first node, and causing the second node to execute a second portion of layers of the first protocol stack; and
providing one or more identifying information from the first node to the second node, wherein the one or more identifying information is configured to, in conjunction with the execution of the second portion of layers of the first protocol stack, authenticate the first node with at least one logical entity in the second communications system, said authentication enabling a connection between the second node and the at least one logical entity.

2. The method of claim 1, where the executing the second portion of layers of the first protocol stack within the second node comprises coupling to a Transmission Control Protocol/Internet Protocol) TCP/IP layer of the first portion of the layers of the first protocol stack in the first node.

3. The method of claim 2, where the executing the first portion of layers of the first protocol stack within the first node comprises coupling to a complementary Transmission Control Protocol/Internet Protocol) TCP/IP layer of the second node.

4. The method of claim 1, further comprising:
causing the second portion of layers of the first protocol stack to derive one or more authentication information; and
based at least on the derived one or more authentication information, the second portion of layers of the first protocol stack encrypting one or more data payloads for a first link between the second node and the at least one logical entity.

5. The method of claim 4, further comprising:
also deriving the one or more authentication information at the first portion of layers of the first protocol stack; and
based at least on the one or more authentication information also derived at the first portion of layers of the first protocol stack, encrypting one or more data payloads for the second portion of layers of the first protocol stack at the first portion of layers of the first protocol stack.

6. The method of claim 1, further comprising receiving the one or more identifying information from a subscriber identity module (SIM) that is not local to the first node.

7. The method of claim 7, where the providing the one or more identifying information from the first node to the second node is performed via at least a public key encryption scheme.

8. The method of claim 8, where the public key encryption scheme comprises receiving a manually entered password from a user input.

9. The method of claim 8, where the public key encryption scheme comprises retrieving a pre-defined public key.

10. The method of claim 1, wherein the first communications system comprises a Wi-Fi compliant network, and the second communications system comprises a Long Term Evolution (LTE) compliant network having one or more eNodeB entities, said at least one logical entity comprising at least one of said one or more eNodeB entities.

11. A wireless station apparatus configured to provide connectivity to a core network, comprising:
a network interface configured to connect to the core network associated with a second radio technology;
a radio interface configured to provide an open wireless network according to a first radio technology different than the second radio technology;
a processor; and
a non-transitory computer readable medium in data communication with the processor and comprising one or more instructions which are configured to, when executed by the processor, cause the wireless station apparatus to, responsive to a subscriber device of the open wireless network requesting access to the core network:
receive one or more identifying information from the subscriber device;
authenticate, via at least the network interface, to the core network based at least on the one or more identifying information, wherein the authentication results in a derivation of one or more authentication keys; and
establish a secure link to the subscriber device via at least the open wireless network based at least on the one or more authentication keys.

12. The wireless station apparatus of claim 11, wherein the non-transitory computer readable medium further comprises one or more instructions which are configured to, when executed by the processor, cause the wireless station apparatus to execute one or more software layers that are uniquely associated with the subscriber device and the second radio technology.

13. The wireless station apparatus of claim 12, wherein:
the executed one or more software layers mimic one or more portions of a call stack associated with the subscriber device; and
the executed one or more software layers are configured to authenticate the subscriber device to the second radio technology.

14. The wireless station apparatus of claim 12, where the received one or more identifying information is received via a public key encryption; and
where the established secure link is based on a symmetric key encryption.

15. A subscriber device configured to communicate with a core network via a wireless station, comprising:
a radio interface, the radio interface configured to communicate with a wireless station, the wireless station configured to communicate with the core network;
a processor; and
a non-transitory computer readable apparatus in data communication with the processor and comprising one or more instructions which are configured to, when executed by the processor, cause the subscriber device to:
provide one or more identifying information to the wireless station;;
receive one or more authentication information from the wireless station; and
establish a secure connection to the wireless station based at least on one or more keys derived from the one or more authentication information.

16. The subscriber device of claim 15, where identifying information comprises a Long Term Evolution (LTE) evolved Packet System (EPS) KASME (Key Access Security Management Entity) encryption key.

17. The subscriber device of claim 16, further configured to authorize the use of its one or more identifying information by at least one other subscriber device.

18. The subscriber device of claim 17, where the at least one other subscriber device shares the secure connection to the wireless station.

19. The subscriber device of claim 17, further configured to request an Internet Protocol (IP) address for the at least one other subscriber device.

20. The subscriber device of claim 15, where the one or more identifying information is provided to the wireless station via a public key encryption scheme.
